(19) United States
(12) Patent Application Publication
(10) Pub. No.: US 2025/0287958 A1
(43) Pub. Date: Sep. 18, 2025

(54) TRACKING PERFORMED DURING MEAT PROCESSING TO SUPPORT ANIMAL SOURCE TRACING

(71) Applicant: Hugo Enterprises, LLC, Denver, CO (US)

(72) Inventors: Roger Pepijn Bodamer, San Carlos, CA (US); Morgan Forrester Fischer, Upper Brookville, NY (US)

(21) Appl. No.: 18/603,780

(22) Filed: Mar. 13, 2024

(51) Int. Cl. A22B 7/00; A22B 5/00; A23L 13/00; B65B 25/06; B65B 57/10; B65B 61/02; B65G 15/30; G06V 20/68

(52) U.S. Cl. CPC A22B 7/007; A22B 5/007; A23L 13/00; B65B 25/065; B65B 57/10; B65B 61/02; B65G 15/30; B65G 2201/0202; G06V 20/68

(57) ABSTRACT

A method comprises: receiving meat having an animal identifier, transporting the meat or a first meat portion on a conveyor during a process, sensors being positioned along the conveyor, and the meat and the first meat portion not being physically marked with the animal identifier; receiving sensor outputs during the process each characterizing the meat or the first meat portion; assigning, by a frontend component implemented using a first processor and a first memory, native identifiers to the meat or to the first meat portion using the sensor outputs; defining, by the frontend component, events regarding the process, the events being defined based on heuristics about the meat or the first meat portion; and storing, by an identifier manager implemented using a second processor and a second memory, the events in an append-only database, wherein the append-only database associates the native identifiers with the animal identifier.

### TECHNICAL FIELD

This document relates to tracking that can be performed during meat processing to support animal source tracing.

### BACKGROUND

Products transported on a conveyor belt are sometimes identified by way of a special marking (e.g., a label, barcode or a radio-frequency identification (RFID) tag) applied to the product. Such identification can serve to track the product during a manufacturing stage or other processing.

However, it may not always be possible, practicable, or desirable to apply a marking to a product for purpose of tracking. For example, in a food processing plant the product (e.g., a portion of meat during meat processing) may not be suitable for having a marking applied to it (e.g., due to a risk of contamination). As another example, even if the risk of contamination were resolved, the nature of the product (e.g., the texture of the surface of a food product during the course of a manufacturing process) may make it difficult or undesirable to apply any kind of marking to the product.

### SUMMARY

In a first aspect, a method comprises: receiving meat that is associated with an animal identifier; transporting the meat or a first meat portion separated from the meat on a conveyor during a process, wherein sensors are positioned along the conveyor, and wherein the meat and the first meat portion are not physically marked with the animal identifier; receiving sensor outputs using the sensors during the process, each of the sensor outputs characterizing the meat or the first meat portion; assigning, by a frontend component implemented using a first processor and a first memory, native identifiers to the meat or to the first meat portion using the sensor outputs; defining, by the frontend component, events regarding the process, the events being defined based on heuristics about the meat or the first meat portion; and storing, by an identifier manager implemented using a second processor and a second memory, the events in an append-only database, wherein the append-only database associates the native identifiers with the animal identifier.

Implementations can include any or all of the following features. The animal identifier is affixed on an animal tag attached to an animal, wherein the meat and the first meat portion are part of the animal. The method further comprises removing the animal tag from the animal in the process before the meat or the first meat portion is transported using the conveyor. The conveyor first transports the meat, and wherein after separation of the first meat portion from the meat, the conveyor transports the first meat portion. A station is positioned adjacent the conveyor, and wherein the separation of the first meat portion from the meat occurs at the station. The method further comprises detecting that the meat enters the station from the conveyor, and subsequently detecting that the first meat portion begins to be transported by the conveyor at the station. The method further comprises registering, after subsequently detecting that the first meat portion begins to be transported by the conveyor at the station, that the first meat portion was separated from the meat at the station. The method further comprises detecting that the meat enters the station from the conveyor, and subsequently detecting that the first meat portion and a second meat portion begin to be transported by the conveyor at the station. The method further comprises registering, after subsequently detecting that the first meat portion and the second meat portion begin to be transported by the conveyor at the station, that the first meat portion and the second meat portion were separated from the meat at the station. The frontend component assigns the native identifiers without the frontend component having access to the animal identifier. The heuristics include at least one selected from the group consisting of: a bounding box defined relative to at least one of the sensor outputs; spatial coordinates for the meat or for the first meat portion, wherein the conveyor includes a conveyor belt and the spatial coordinates indicate a position of the meat or the first meat portion at the conveyor belt; an image of the meat or the first meat portion, wherein at least one of the sensors includes an image sensor that generates the image of the meat or the first meat portion; a shape of the meat or the first meat portion; an overlap between the first meat portion and a second meat portion at the conveyor belt; a conveyor pattern positioned at the conveyor belt; a location of the meat or the first meat portion at the conveyor belt; a confidence of detection at the conveyor belt regarding the meat or the first meat portion; an outline of the meat or the first meat portion; a contour of the meat or the first meat portion or the first meat portion; and a volume of the meat or the first meat portion or the first meat portion. The heuristics include at least the conveyor pattern and wherein the conveyor pattern includes a QR code. At least one other of the heuristics are used together with the QR code in defining the events. The heuristics include at least one selected from the group consisting of: a timestamp for the meat or the first meat portion during the process; a velocity of the meat or the first meat portion; identification of a zone along the conveyor where any of the sensors detects the meat or the first meat portion; a place along the conveyor where any of the sensors most recently detected the meat or the first meat portion; and a weight of the first meat portion or the first meat portion. The method further comprises managing, during the process, processing of the meat or the first meat portion at any of multiple zones defined along the conveyor. The multiple zones include an end zone of the process, the method further comprising applying packaging to the meat or to the first meat portion at the end zone. The method further comprises affixing a marking to the packaging, the marking including a product identifier for the meat or for the first meat portion. The method further comprises tracing a source of the meat or a source of the first meat portion using the product identifier and the append-only database. The method further comprises providing a report regarding the source of the meat or the source of the first meat portion. Each of the native identifiers is specific to a corresponding one of the sensors. The process comprises butchering and dressing of animals.

In a second aspect, a computer program product is stored in a non-transitory medium, the computer program product including instructions that when executed cause a processor to perform operations including: wherein meat is received that is associated with an animal identifier; wherein the meat or a first meat portion separated from the meat is transported on a conveyor during a process, wherein sensors are positioned along the conveyor, and wherein the meat and the first meat portion are not physically marked with the animal identifier; receiving sensor outputs using the sensors during the process, each of the sensor outputs characterizing the meat or the first meat portion; assigning, by a frontend component implemented using a first processor and a first memory, native identifiers to the meat or to the first meat portion using the sensor outputs; defining, by the frontend component, events regarding the process, the events being defined based on heuristics about the meat or the first meat portion; and storing, by an identifier manager implemented using a second processor and a second memory, the events in an append-only database, wherein the append-only database associates the native identifiers with the animal identifier.

In a third aspect, a system comprises: a conveyor to transport, during a process, meat or a first meat portion separated from the meat, the meat being associated with an animal identifier, wherein the meat and the first meat portion are not physically marked with the animal identifier; sensors that are positioned along the conveyor, the sensors generating sensor outputs during the process, each of the sensor outputs characterizing the meat or the first meat portion; an append-only database; and one or more processors to execute instructions stored in one or more memories to operate: a frontend component that assigns native identifiers to the meat or to the first meat portion using the sensor outputs, and that defines events regarding the process based on heuristics about the meat or the first meat portion; and an identifier manager that stores the events in the append-only database, wherein the append-only database associates the native identifiers with the animal identifier.

Implementations can include any or all of the following features. The conveyor includes a conveyor belt providing a surface on which the meat or the first meat portion is placed. The conveyor includes conveyor hangers from which the meat or the first meat portion hangs. The system further comprises at least one station along the conveyor. The system further comprises: multiple zones defined along the conveyor; and a zone manager, operated by the one or more processors, that manages, during the process, processing of the meat or the first meat portion at any of the multiple zones. At least one of the sensors includes an image sensor, and wherein the sensor output for the image sensor includes an image of the meat or the first meat portion. At least one of the sensors includes a light ranging and detection (LiDAR) device, and wherein the sensor output for the LiDAR device includes a LiDAR point cloud of the meat or the first meat portion. At least one of the sensors includes an infrared (IR) detector, and wherein the sensor output for the IR detector includes an IR image of the meat or the first meat portion. The system further comprises an object detection system formed at least in part by the sensors and the frontend component. The frontend component includes multiple frontend components, each of the multiple frontend components integrated with a corresponding one of the sensors. The system further comprises an animal source record database that includes the animal identifier, and wherein the append-only database comprises: an append-only events database in which the identifier manager stores the events; and an append-only mapping database storing respective mappings between at least the native identifiers and the animal identifier. The mappings directly associate the animal identifier with a product identifier that was included in a marking affixed to a packaging of the meat or the first meat portion. The mappings indirectly associate, via the native identifiers, the animal identifier with a product identifier that was included in a marking affixed to a packaging of the meats or the first meat portion. The system further comprises reporting software being executed to generate a report on source tracing for the meat or the first meat portion. The reporting software provides a view function or a query function for the source tracing for the meat or the first meat portion.

In a fourth aspect, a method comprises: receiving a first product identifier from packaging of a meat portion, wherein source tracing is to be performed for the meat portion; identifying, using the first product identifier, at least one animal identifier in an append-only database, the append-only database storing events defined regarding a process in which meat or the meat portion separated from the meat were transported using a conveyor, the events having been defined based on heuristics about the meat or the meat portion, wherein native identifiers were assigned to the meat or to the meat portion using sensor outputs of sensors positioned along the conveyor, and wherein the append-only database associates the native identifiers with the at least one animal identifier; and identifying at least one second product identifier in the append-only database, the at least one second product identifier identified as being associated with the at least one animal identifier identified for the first product identifier.

Implementations can include any or all of the following features. The method comprises generating a report on source tracing for the meat or the meat portion. Generating the report comprises evaluating a direct association between the animal identifier with a product identifier that was included in a marking affixed to a packaging of the meat or the first meat portion. Generating the report comprises evaluating an indirect association, via the native identifiers, between the animal identifier with a product identifier that was included in a marking affixed to a packaging of the meats or the first meat portion.

In a fifth aspect, a computer program product is stored in a non-transitory medium, the computer program product including instructions that when executed cause a processor to perform operations including: receiving a first product identifier from packaging of a meat portion, wherein source tracing is to be performed for the meat portion; identifying, using the first product identifier, at least one animal identifier in an append-only database, the append-only database storing events defined regarding a process in which meat or the meat portion separated from the meat were transported using a conveyor, the events having been defined based on heuristics about the meat or the meat portion, wherein native identifiers were assigned to the meat or to the meat portion using sensor outputs of sensors positioned along the conveyor, and wherein the append-only database associates the native identifiers with the at least one animal identifier; and identifying at least one second product identifier in the append-only database, the at least one second product identifier identified as being associated with the at least one animal identifier identified for the first product identifier.

In a sixth aspect, a packaging apparatus comprises: one or more sensors; a packaging machine configured to package meat or meat portions using packaging material, wherein the packaging machine packages one or more of the meat or the meat portions into each of multiple packages, the meat or meat portions arriving at the packaging apparatus as part of meat processing in which native identifiers are assigned to the meat or to the meat portion using outputs of the one or more sensors, wherein events defined regarding the meat processing are stored in an append-only database; and a labeler configured to label each of the multiple packages with a corresponding product identifier, the product identifier being specific to the respective package.

Implementations can include any or all of the following features. The packaging machine is configured for vacuum sealing each of the multiple packages. The packaging material includes a polymer material. The packaging material comprises a bag of the polymer material, wherein the packaging material is configured for the packaging machine to place the meat or meat portion inside the bag. The packaging apparatus further comprises a sealer that seals the polymer material. The labeler is configured to print the product identifier onto the packaging material. The labeler is configured to apply a label onto the packaging material, wherein the label includes the product identifier.

In a seventh aspect, an identifier manager apparatus is implemented using one or more processors to execute instructions stored in one or more memories, the identifier manager comprising: an interface for the identifier manager to receive events defined regarding meat processing, wherein in the meat processing native identifiers are assigned to meat or meat portion using outputs of one or more sensors; and data processing component to associate the native identifiers with an animal identifier for the meat or the meat portion, and store the events in an append-only database.

Implementations can include any or all of the following features. The identifier manager apparatus further comprises a tracking component configured for audit tracking with regard to the meat or meat portion. The tracking component is configured for performing the audit tracking at least in response to identification of the meat or meat portion during the meat processing. The identification of the meat or meat portion during the meat processing is detected by the one or more sensors. Pointing to the meat or the meat portion is performed during the meat processing within a field of view of the one or more sensors, and wherein the one or more sensors recognizes the pointing as the identification of the meat or meat portion. Subsequent to the meat processing a package containing the meat or meat portion was labeled with a product identifier, and wherein the tracking component is configured for performing the audit tracking at least in response to presentation of the product identifier. The presentation of the product identifier is detected by the one or more sensors. The one or more sensors detects the presentation of the product identifier based on packaging material of the package being brought within a field of view of the one or more sensors.

### BRIEF DESCRIPTION OF DRAWINGS

FIG. 1 schematically shows an example of tracking meat and/or meat portions separated from the meat during a process that involves transportation using a conveyor.

FIG. 2 shows an example of a system that tracks products and/or portions separated from the product(s) during a process that involves transportation using a conveyor belt.

FIG. 3 shows an example of a product (e.g., meat or a meat portion) transported using a conveyor hanger.

FIG. 4 shows a system that supports tracking of animal sources during meat processing so that animal source tracing of animal source information can be performed.

FIG. 5 shows some examples of heuristics based on which events can be defined in methods and/or systems described herein.

FIG. 6 shows other examples of heuristics based on which events can be defined in methods and/or systems described herein.

FIG. 7 shows another example of a system that supports tracking of animal sources during meat processing so that animal source tracing of animal source information can be performed.

FIGS. 8-9 show examples of methods.

FIG. 10 shows an example of meat processing.

FIG. 11 shows an example of a packaging apparatus that can be used as part of the meat processing of FIG. 10.

FIG. 12 shows another example of a packaging apparatus that can be used as part of the meat processing of FIG. 10.

FIG. 13 shows another example of a packaging apparatus that can be used as part of the meat processing of FIG. 10.

FIG. 14 shows an example of an append-only database implemented using a file system.

FIG. 15 shows an example of an append-only database implemented using immutable objects.

FIG. 16 shows an example of an append-only database implemented using a log-structured file system.

FIG. 17 shows an example of an append-only database implemented using a ledger with a blockchain.

FIG. 18 shows an example of an ID manager apparatus.

FIG. 19 shows an example of an audit tracker apparatus.

FIG. 20 shows an example of initiating an audit based on meat or a meat portion.

FIG. 21 shows an example of initiating an audit based on a product identifier.

FIG. 22 illustrates an example architecture of a computing device.

### DETAILED DESCRIPTION

The present disclosure describes systems, techniques, and/or articles of manufacture that provide tracking during meat processing to support animal source tracing. The systems, techniques, and/or articles of manufacture can also or instead be used in performing such animal source tracing. For example, the present subject matter can be applied in a meat processing plant where the product is an animal carcass transported on a conveyor and being tracked by sensors based on heuristics. Implementations can provide improved source verification of one or more types of products. For example, the present subject matter can facilitate traceability of essentially all portions of an animal carcass to the original animal, including, but not limited to, for purposes of removing all pieces of a potentially unhealthy or contaminated animal from a food manufacturing process. The present subject matter can facilitate improved reporting of a number of statistics regarding meat processing. As another example, the present subject matter can provide traceability of sub-components, components, apparatuses, and/or systems of an assembly process.

Examples described herein refer to a conveyor pattern applied to a conveyor belt (e.g., to an outwardly facing surface thereof). As used herein, a conveyor pattern includes one or more markings that can be uniquely identified using an image sensor. The markings can be synthetic (e.g., deliberately applied) and/or natural (e.g., including one or more unique features not designed/applied by deliberate action, including, but not limited to, irregularities from a manufacturing process). In some implementations, a pattern can include a so-called quick response (“QR”) code. One or more types of QR code can be used. In some implementations, the QR code can be compatible with one or more standards. For example, the QR code can be compatible with the Association for Automatic Identification and Mobility International standard from 1997; the Japanese Industrial Standard X 0510; the International Organization for Standardization/International Electrotechnical Commission (ISO/IEC) 18004:200; the ISO/IEC standard 18004:2006; and/or the ISO/IEC standard 18004:2015. In some implementations, a pattern can include a barcode. One or more types or barcode can be used. The barcode can be compatible with one or more symbologies. In some implementations, the barcode can be compatible with a linear symbology. For example, the linear symbology can be a discrete symbology (e.g., separating characters with a space that does not convey information). As another example, the linear symbology can be a continuous symbology (e.g., having characters that usually abut each other). As another example, the linear symbology can be a many-width (e.g., more than two-width) symbology (e.g., having relatively wider, and relatively narrower, bars and spaces). As another example, the linear symbology can be a two-height symbology (e.g., having relatively tall, and relatively short, bars and spaces). In some implementations, a pattern can include one or more geometric shapes in two or more dimensions. For example, the pattern can include one or more of a straight line, a curved line, a polygon, a regular shape, an irregular shape, a texture, a reflectivity, an elevation, or a depression, or combinations thereof. In some implementations, a pattern can include one or more regions of reduced material density, and/or one or more regions of increased material density. A reduced material density can include a recess or an opening in a material (e.g., a blind hole or a through hole).

A pattern in form of one or more applied markings can be based on any of multiple techniques for applying a pattern. A color and/or shading can be applied to the surface of the conveyor belt. In some implementations, a color/shading can be introduced as part of the process of manufacturing the conveyor belt. For example, the conveyor belt can be designed so that one or more patterns appear on its surface (e.g., by way of threading, interleaving, weaving, and/or inlay). In some implementations, a color/shading can be applied to an already manufactured conveyor belt. For example, this can be done to an existing conveyor belt in a factory setting without the need to obtain a new system of conveyor belts. In some implementations, pigment can be applied to the conveyor belt surface to form at least part of a pattern. For example, one or more types of paint can be applied. In some implementations, a dye can be applied to the conveyor belt surface to form at least part of a pattern. In some implementations, a pattern can be applied by affixing (e.g., permanently affixing) one or more objects to the surface of the conveyor belt. The object(s) can be made of any material that is suitable considering the operation of the conveyor belt and/or the types of products to be transported.

Examples herein refer to recognizing a pattern or otherwise determining that a product is positioned at or near a pattern. Patterns can be predefined in a pattern catalog, which can include any tangible medium permissive to at least temporary persistence of pattern information. In some implementations, a pattern catalog can be used by a processor-based system to recognize patterns. For example, such a pattern catalog can be embodied in any computer-readable non-transitory medium, including, but not limited to, in electronically stored digital information.

Examples herein refer to products and processes of manufacture. A product can include one or more materials, manufactures, and/or compositions of matter. A product can include natural material (e.g., meat or another animal product, and/or plant-based material) and/or synthetic material (e.g., metal, an alloy, a chemical compound, plastic, or another composite material). A product can refer to an item during any or all of multiple states of separation from one state into another. For example, in a meat processing plant a product can refer to a living animal, a slaughtered animal, a carcass, half of an animal carcass, a portion of an animal carcass, and/or a food item (e.g., a steak). A product can refer to an item during any or all of multiple states of assembly. For example, in an assembly process a product can refer to a sub- component of an apparatus; to a component of the apparatus including the sub-component; to the apparatus including the component; or to a system including the apparatus. In some implementations, a product can undergo both separation and assembly during manufacturing. In some implementations, a process of manufacture can include both separation and assembly of the product(s).

Examples described herein refer to an append-only database. As used herein, an append-only database restricts editing so that new data can be appended to existing data, but the state of the existing data cannot be changed. The append-only database can be implemented by exercising access control over a computer data storage. To provide an append-only database, a file system can implement an append-only permission. A log file is an example of a data structure that can be used for an append-only database. The append-only database facilitates animal source tracing by creating immutable data records that reflect events taking place during a process (e.g., meat processing), such as the separation of meat into portions, or the combination of portions with each other.

Examples described herein refer to a sensor. As used herein, a sensor is any device generating a sensor output that characterizes meat or a meat portion. The sensor can be placed adjacent a conveyor that transports the meat or the meat portion. Examples of sensors include, but are not limited to, an image sensor (e.g., a camera), a light ranging and detection (LiDAR) device (e.g., emitting light from a laser or a light-emitting diode), an infrared (IR) detector (e.g., any detector sensitive to IR radiation), or a scale (e.g., an electronic weighing scale that measures weight using one or more strain gauges or other transducers). An image can be captured using any suitable optical equipment by way of, for example, visible light, IR radiation, and/or ultraviolet radiation. An image sensor can include, or be included within, a camera, a charge-coupled device, and/or another optical detector capable of registering light.

Examples herein refer to tracing one or more products back to at least one earlier product in a different state of separation and/or state of assembly and/or mode of transportation. In some implementations, essentially all portions of an animal carcass can be tracked, in the meat processing plant, to facilitate tracing to the original animal and/or to another portion of the same animal. For example, tracing can involve identifying substantially all pieces of organic matter that originated with a specific animal.

Examples described herein refer to animals. As used herein, an animal includes any living or once-living organism that is being subjected to a process and that is being tracked during that process to facilitate animal source tracing. Animals include, but are not limited to, ruminants, hoofed mammals, or poultry. For example, animals can include bovines, cattle, bison, buffalos, sheep, boar, pigs, turkeys, or chicken.

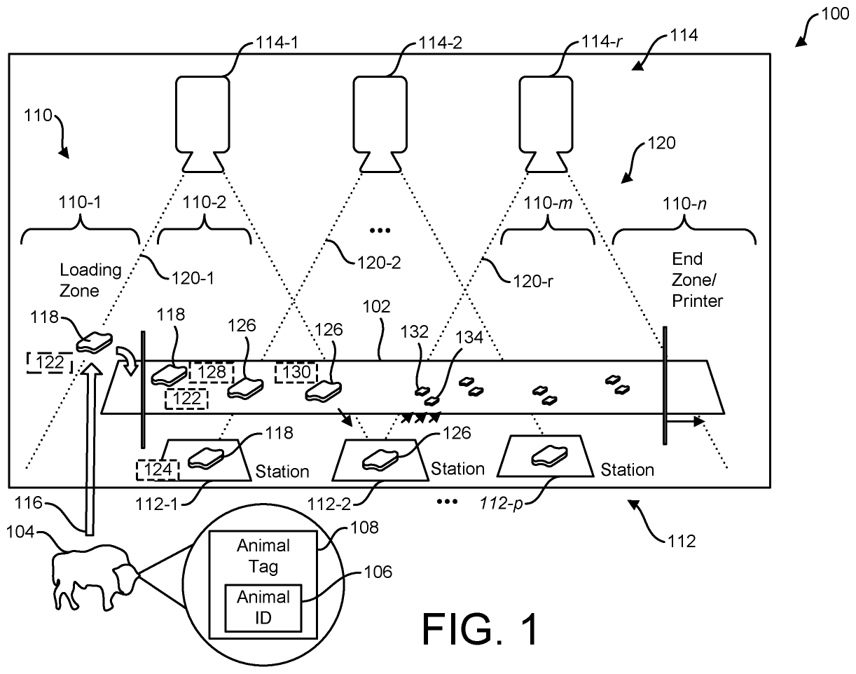

FIG. 1 schematically shows an example 100 of tracking meat and/or meat portions separated from the meat during a process that involves transportation using a conveyor 102. The example 100 and/or the conveyor 102 can be used with one or more other examples described elsewhere herein. In some implementations, the example 100 involves meat processing performed using a system, and this context will be used in the following to illustrate features of such a system. For example, meat processing can involve butchering and dressing of an animal 104. The animal 104 is here schematically illustrated using a particular shape for illustrative purposes only, and other kinds of animals can be used with the example 100.

The animal 104 is associated with an animal identifier (ID) 106. The animal ID 106 can be physically affixed to the animal 104 in any of multiple ways. In some implementations, the animal ID 106 is attached to the animal 104 using an animal tag 108. Any of multiple kinds of animal tag can be used. In some implementations, the animal tag 108 is an ear tag that can be attached to the ear of the animal 104. For example, the animal ID 106 includes a string of characters (e.g., a code) that is affixed to the animal tag 108. As another example, the animal tag 108 is an RFID tag programmed with the animal ID 106. The animal 104 may have been associated with the animal ID 106 (e.g., may have had the animal tag 108 attached) for a shorter or longer time before the processing of the example 100 is initiated. For example, the animal ID 106 is assigned, and the animal tag 108 is attached, to the animal 104 shortly after birth. However, the animal 104 may not be directly identifiable using the animal ID 106 once the processing of the example 100 begins. For example, to avoid the risk of contamination, the animal tag 108 may be removed from the animal 104 shortly after slaughter. As another example, the body part where the animal tag 108 is attached (e.g., an ear) may become separated from the rest of the carcass of the animal 104 (e.g., by removal of the head) at about the time when the example 100 begins, meaning that the rest of the carcass is no longer physically in unison with the animal tag 108 and therefore is not physically marked with the animal ID 106. Instead, the present subject matter provides ways of tracking the meat from the animal 104 (which may be in form of meat portions separated from other parts of the carcass) so that the animal source of such meat/meat portions can later be traced.

The example 100 involves processing of meat in each of n number of zones 110 defined along the conveyor 102, where n=2, 3, 4 . . . . Here, the zones 110 includes zone 110-1, 110-2, 110-m, through 110-n, respectively, where 1≤m≤n−1. In some implementations, the zone 110-1 can be a loading zone and the zone 110-n can be an end zone. For example, in the end zone packaging can be applied to meat or a meat portion from the animal 104 to facilitate storage and/or further transport. Accordingly, the example 100 can involve managing the processing of meat or meat portions from the animal 104 in the zones 110.

The example 100 can involve use of any or all of q number of stations 112 that are positioned along the conveyor 102, where q=1, 2, 3, . . . . Here, the example 100 uses stations 112-1, 112-2, through 112-p, where 1≤p≤q. The station(s) 112 can be used for particular processing of the meat or meat portions from the animal 104. For example, meat portions that are intended to become packaged products can be separated from each other at the station(s) 112. As another example, scrap meat can be removed, at the station(s) 112, from a meat portion that is intended to become a packaged product. As another example, meat portions can be combined with each other, at the station(s) 112, to form meat intended to become a packaged product.

The example 100 can involve use of any or all of s number of sensors 114 that are positioned along the conveyor 102, where s=1, 2, 3, . . . . Here, the example 100 uses sensors 114-1, 114-2, through 114-r, where 1≤r≤s. The sensor(s) 114 can be used for tracking of the meat or meat portions from the animal 104.

Here, an arrow 116 schematically illustrates that the animal 104 is slaughtered and that meat 118 is obtained from the animal 104 and is to be subjected to the meat processing that the example 100 involves. For example, the meat 118 can be characterized as the carcass, or any portion of the carcass, of the animal 104. The meat 118 will be transported by the conveyor 102 as part of the meat processing. The animal tag 108 can be removed from the animal 104 before the meat 118 is transported using the conveyor 102.

At the beginning of the meat processing, the meat 118 enters into any or all of ranges 120. Here, the sensor 114-1 has a range 120-1. The range 120-1 can have any shape, and is here illustrated using a triangular shape (e.g., to represent a cone) for illustrative purposes only. For example, when the sensor 114-1 is an image sensor or a LiDAR, the range 120-1 represents a field-of-view of the image sensor or the LiDAR. Similarly, the sensor 114-2 has a range 120-2, and the sensor 114-r has a range 120-r. The zones 110 can be, but are not necessarily, coterminous or coextensive with the ranges 120. In some implementations, one or more of the zones 110 can be defined in any of the ranges 120. For example, one or more of the zones 110 can straddle a boundary of any of the ranges 120. In some implementations, one or more of the ranges 120 can extend in any of the zones 110. For example, one or more of the ranges 120 can straddle a boundary of any of the zones 110.

The system will receive sensor outputs from the sensors 114 that characterize the meat or meat portions transported by the conveyor 102. Here, the sensor output of the sensor 114-1 will reflect detection of the meat 118 at least partially within the range 120-1. The system will assign (e.g., as described in examples below relating to a frontend component) native IDs to objects detected in the sensor output(s). For example, a native ID 122 is assigned to the meat 118 based on the sensor output of the sensor 114-1. The sensor 114-1 does not have access to the animal ID 106; rather, the term “native” here indicates that the native ID 122 is assigned based on object detection in the sensor output, not based on any prior knowledge about the meat 118. As such, each of the assigned native IDs is specific to a corresponding one of the sensors 114 that generated the sensor output. The native ID 122 can be maintained for the meat 118 as long as the meat 118 is within the range 120-1; that is, the system may continuously track the meat 118 (by object detection) throughout the range 120-1 and may not assign a new native ID to the meat 118 during such tracking. Here, the meat 118 is schematically shown as being positioned on a surface of the conveyor 102 (e.g., on top of a conveyor belt) as part of being transported during the process.

From the conveyor 102, the meat 118 may enter the station 112-1. That is, the system can detect that the meat 118 enters the station 112-1 from the conveyor 102. At the station 112-1, the meat 118 can be associated with a native ID 124. In some implementations, the station 112-1 is within the range 120-1 of the sensor 114-1, and the native ID 124 can then represent that the native ID 122 is maintained as long as the meat 118 is tracked by the object detection associated with the sensor 114-1. In other implementation, the station 112-1 is not within the range 120-1 of the sensor 114-1, but rather is within the range 120 of another one of the sensors 114 (e.g., the range 120-2 of the sensor 114-2). The native ID 124 can then be a new native ID assigned to the meat 118 by the other one of the sensors.

The station 112-1 can be positioned adjacent the conveyor 102, and a separation of a meat portion 126 from the meat 118 can occur at the station 112-1. The meat portion 126 can enter the conveyor 102 from the station 112-1. That is, subsequent to detecting that the meat 118 enters the station 112-1 from the conveyor 102, the system can detect that the meat portion 126 enters the conveyor 102 from the station 112-1. The system can detect, after subsequently detecting that the meat portion 126 begins to be transported by the conveyor 102 at the station 112-1, that the meat portion 126 was separated from the meat 118 at the station 112-1.

The meat portion 126 can initially be within the range 120-1 of the sensor 114-1. Based on the sensor output of the sensor 114-1, the system can assign a native ID 128 to the meat portion 126. The meat portion 126 can be transported into the range 120-2 of the sensor 114-2. Based on the sensor output of the sensor 114-2, the system can assign a native ID 130 to the meat portion 126.

From the conveyor 102, the meat portion 126 may enter the station 112-2. That is, the system can detect that the meat portion 126 enters the station 112-2 from the conveyor 102. At the station 112-2, the meat portion 126 can be separated into at least two meat portions. The system can detect that meat portions 132 and 134 are separated from the meat portion 126 at the station 112-2. For example, subsequent to detecting that the meat portion 126 enters the station 112-2 from the conveyor 102, the system can detect that meat portions 132 and 134 begin to be transported by the conveyor 102. Based on the sensor output of the sensor 114-2, the system can assign respective native IDs to each of the meat portions 132 and 134. Also or instead, based on the sensor output of the sensor 114-r, the system can assign other respective native IDs to each of the meat portions 132 and 134. That is, the conveyor 102 first transports the meat 118, thereafter transports the meat portion 126, and thereafter transports the meat portions 132 and 134.

In the zone 110n, packaging can be applied to the meat portions 132 and 134 and/or to any other meat that originated with the animal 104 in the example 100. A marking can be applied to the packaging to facilitate tracking and identification. The marking can include a product ID for the meat or meat portion. The product ID can be affixed in form of a QR code, bar code, alphanumerical code, or RFID tag, to name just a few examples.

In the event that animal source tracing becomes necessary, the product ID may be a starting point for such tracing. For example, when a food product purchased by a consumer is found to be defective, the product ID on its packaging can provide information that allows tracing, using the present subject matter, to one or more animals from which the meat or meat portion originated. The native IDs assigned in the example 100 can be used for defining events regarding the meat processing. Such events can be stored in an append-only database (e.g., as described in examples below) and can be used for tracing meat back to its animal source. Namely, a source of the meat or meat portion can be traced using the product ID and the append-only database (e.g., as described in examples below).

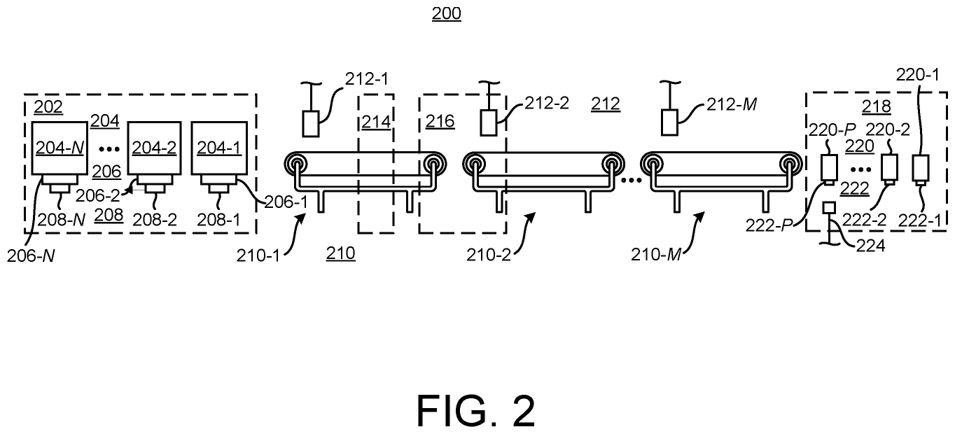

FIG. 2 shows an example of a system 200 that tracks products and/or portions separated from the product(s) during a process that involves transportation using a conveyor belt. The system 200 can be used with one or more other examples described elsewhere herein. For example, the conveyor 102 in FIG. 1 can be included in the system 200. As another example, the example 100 in FIG. 1 can be performed using, or by, the system 200. Some aspects of the system 200 are schematically illustrated for clarity, and only portions of the system 200 are shown for simplicity. In some implementations, the system 200 can include one or more other components or stages that are not illustrated here.

The system 200 includes a preceding station 202. The preceding station 202 is here schematically illustrated as a region delineated by a dashed outline. The preceding station 202 represents one or more stages, processing operations, and/or preparatory steps taking place before subsequent operations in the system 200. The preceding station 202 involves one or more products that will be subject to further manufacturing operations (e.g., separation and/or assembly and/or transportation) within the system 200. The preceding station 202 is shown to include products 204, here illustrated as products 204-1, 204-2, . . . , 204-N, respectively, where N is a positive integer greater than two. The products 204 can be identical to each other, or two or more of the products 204 can be different from each other. Each of the products 204 can be associated with a corresponding one of carriers 206, here illustrated as carriers 206-1, 206-2, . . . , 206-N, respectively, where N is a positive integer greater than two. Each of the carriers 206 can include structure designed to support a corresponding one of the products 204, including, but not limited to, by the product 204 hanging from the carrier 206, or by the product 204 resting on or within the carrier 206. For example, one or more of the carriers 206 can include a conveyor hanger (e.g., a hook, such as a meat hook). The carriers 206 can be identical to each other, or two or more of the carriers 206 can be different from each other. Each of the carriers 206 can be associated with a corresponding one of patterns 208, here illustrated as patterns 208-1, 208-2, . . . , 208-N, respectively, where N is a positive integer greater than two. Each of the patterns 208 can include a pattern that identifies a corresponding one of the products 204. The patterns 208 can be of the same type as each other, or two or more of the patterns 208 can be of different types. One or more of the patterns 208 can be referred to as a carrier pattern due to being associated with (e.g., affixed to) the corresponding carrier 206. The system 200 can store a mapping that associates the animal ID of a particular animal carcass with the particular one of the patterns 208 of the specific one of the carriers 206 where the animal carcass is located.

In some implementations, the system 200 is operated in a meat processing plant. For example, each of the products 204 can be a carcass of a respective animal, wherein the preceding station 202 serves to perform one or more operations that prepare the carcasses for subsequent stages of the meat processing plant. In some implementations, each of the carriers 206 can be a meat hook configured to hold meat, the meat hook attached to a trolley configured to move along an overhead track in the meat processing plant.

In some implementations, the system 200 is operated in an assembly plant. For example, each of the products 204 can be a sub-component of a component, a component of an apparatus, an apparatus, and/or a system including the apparatus, wherein the preceding station 202 serves to perform one or more operations that prepare the products 204 for subsequent stages of the assembly plant.

Each of the carriers 206 is uniquely associated with the corresponding one of the products 204 by way of the product 204 being carried only by that one of the carriers 206. As a result, one or more of the patterns 208 that is affixed to the carrier 206 can therefore become uniquely associated with the corresponding one of the products 204 (at least during a certain period of time). That is, as long as the products 204 are associated with their respective ones of the carriers 206, this association may be sufficient for tracking purposes, and a computer system (not shown) can maintain information corresponding to the respective patterns 208. At some point during the processing in the system 200, however, it may become necessary or practical to no longer have a physical structure (e.g., a tag carrying a marker) carrying the identification of the corresponding pattern 208. As such, a method performed by, or using, the system 200 can include registering a carrier pattern. In some implementations, one or more of the patterns 208 can be registered as part of performing the method. For example, the registration of the carrier pattern can be done based on detection of the carrier pattern at a carrier (e.g., one of the carriers 206) that holds the product. Such a carrier pattern can be associated with the identification of a product, for example as will be described below.

The system 200 can include one or more conveyors 210 (e.g., belt conveyors), here illustrated as conveyors 210-1, 210-2, . . . , 210-M, respectively, where M is a positive integer greater than two. The conveyors 210 can be identical to each other, or two or more of the conveyors 210 can be different from each other. One or more of the conveyors 210 can include a conveyor belt fitted onto multiple pulleys and running as an endless loop. Such a conveyor belt can provide a surface on which a product (e.g., meat or a meat portion) can be placed. For example, a conveyor belt can be made of a flexible medium and/or of segments hinged to each other, and can be wrapped around two or more drums while also being supported by one or more smooth surfaces. The conveyor belt can be advanced in either or both directions by way of one or more motors. For example, one or more pulleys can be driven to advance the conveyor belt. In this example, each of the conveyors 210 can be configured to advance the products 204 in a direction away from the preceding station 202 (e.g., toward the right in the present illustration). As such, the conveyor belts of the conveyors 210 can be driven (continuously or intermittently) in a clockwise direction in the present example. Each of the conveyor belts of the conveyors 210 can be provided with patterns that can be used for identification of the products 204, for example as will be described below. As another example, one or more (e.g., all) of the conveyor belts of the conveyors 210 can be without any patterns or other distinctive markings.

The system 200 can include one or more sensors 212, here illustrated as sensors 212-1, 212-2, . . . , 212-M, respectively, where M is a positive integer greater than two. The sensors 212 can be identical to each other, or two or more of the sensors 212 can be different from each other. Each of the conveyors 210 can have at least one of the sensors 212 associated therewith. There can be at least as many of the sensors 212 as the number of the conveyors 210. In some implementations, one or more of the conveyors 210 can have at least two of the sensors 212. The sensors 212 are configured to generate respective sensor outputs that characterize the products 204 (e.g., meat or meat products).

One or more of the products 204 can be placed on the conveyors 210 to transport the product(s) 204 from the preceding station 202 to one or more subsequent stages handled by the system 200. In some implementations, at the beginning of such transportation the product 204-1 is placed on the conveyor belt of the conveyor 210-1. Once positioned, the product 204-1 will be within a range (e.g., a field-of-view) of a sensor 212-1. As such, the sensor 212-1 can generate a sensor output that characterizes the product 204-1. The system 200 can assign a native ID to the define an event product 204-1 based on the sensor output of the sensor 212-1. That native ID can be used for defining an event based on heuristics about the product 204-1.

The product 204-1 that is placed on the conveyor belt of the conveyor 210-1 can be transported onto one or more of the conveyors 210-2 through 210-M as part of the processing in the system 200. Likewise, the products 204-2 through 204-N can in turn be placed on the conveyor belt of the conveyor 210-1 and can be transported onto one or more of the conveyors 210-2 through 210-M as part of the processing in the system 200.

The system 200 can include one or more stations where at least one operation can be performed on, or otherwise applied to, the product after it arrives. Such operations can involve inspection of the product, treatment of the product, separation of the product into two or more products, and/or assembly of two or more products into a new product, and/or combinations thereof. Here, the system 200 has a station 214 that is positioned along the conveyor 210-1, and a station 216 that is positioned at one end of the conveyor 210-1. Each of the stations 214 and 216 is here schematically illustrated as a region delineated by a dashed outline, and represents one or more stages, processing operations, and/or steps taking place before subsequent operations in the system 200. For example, the product 204-1 can enter the station 214 after being transported by the conveyor belt less than the entire length of the conveyor 210-1. As another example, the product 204-1 (or part thereof, or an assembly including the product 204-1) can enter the station 216 after being transported by the conveyor belt the entire length of the conveyor 210-1. The event of the product 204-1 disappearing from the conveyor 210-1 at the station 214 or 216 can be referred to as a detection of a station entry by the system 200. For example, station entry occurs automatically or by way of intervention by a human operator.

A product can enter one of the conveyors 210 at any of the stations 214 or 216. In some implementations, the product 204-1 can be separated (e.g., divided) into at least two products at either of the stations 214 or 216. For example, the product 204-1 can be meat, and the meat can be separated into at least one meat portion. As such, one or more of the at least two resulting products can enter the conveyor 210-1 at the station 214, or can enter the conveyor 210-2 at the station 216, as the case may be. As another example, the product 204-1 can be assembled (e.g., combined) with at least one other product at either of the stations 214 or 216. As such, the resulting product can enter the conveyor 210-1 at the station 214, or can enter the conveyor 210-2 at the station 216, as the case may be. Such resulting product(s) can be subjected to identification essentially in the same way as for the product 204-1. In some implementations, the sensor 212-1 (or another of the sensors 212 associated with the conveyor 210-1) can generate a sensor output while the resulting product(s) is/are positioned on that conveyor belt. In some implementations, the sensor 212-2 associated with the conveyor 210-2 can generate a sensor output while the resulting product(s) is/are positioned on that conveyor belt. The system can detect or deduce that meat has been separated into one or more meat portions based on the occurrence of events regarding any particular station. For example, if a relatively larger piece of meat enters a station from a conveyor belt and the next event detected by the system is that one or more products enter the conveyor belt at the station, the system can associate the respective native IDs of the incoming and outgoing products with each other. In this way, the system can perform tracking between two or more products across the processing that takes place at one or more stations so as to facilitate traceability regarding product origin.

The system 200 can include a packaging station 218. The packaging station 218 is here schematically illustrated as a region delineated by a dashed outline, and represents one or more stages, processing operations, and/or steps taking place before subsequent operations. In some implementations, products that have been processed in the system 200—e.g., by being transported by one or more of the conveyors 210—can be packaged for further transportation at the packaging station 218. The packaging station 218 is shown to include products 220, here illustrated as products 220-1, 220-2, . . . , 220-P, respectively, where P is a positive integer greater than two. The products 220 can be identical to each other or two or more of the products 220 can be different from each other. Each of the products 220 can be associated with a corresponding one of product IDs 222, here illustrated as product IDs 222-1, 222-2, . . . , 222-P, respectively, where P is a positive integer greater than two. Each of the product IDs 222 can include a product ID that identifies a corresponding one of the products 220. The product IDs 222 can be of the same type as each other, or two or more of the product IDs 222 can be of different types. The product IDs 222 can be affixed to the corresponding product 220 during packaging. The packaging station 218 can include at least one image sensor 224 that can capture an image of at least one of the product IDs 222 and thereby identify the corresponding one of the products 220. Note that the products 204 at the preceding station 202 are uniquely associated with the patterns 208 by way of being carried by respective ones of the carriers 206 (and the patterns 208 may have a mapping to the corresponding animal ID of the respective animal); the products 220 at the packaging station 218, moreover, are likewise uniquely associated with the product IDs 222 by way of the product IDs 222 being affixed to the products 220. During transportation by the conveyors 210, by contrast, such an immediate and physical association between a product and an ID may not exist. In some implementations, during the transportation by the conveyors 210, it may not be practical or possible or desirable to use patterns that are affixed, or otherwise directly applied, to the products. For example, the animal tag that an animal may initially have carried, may have been removed (or that portion of the animal may have been separated) before transport takes place at the conveyors 210. Rather, the identification of the products during transportation by the conveyors 210 can be done by way of defining events based on sensor output and heuristics about meat and meat portions, for example as described elsewhere herein.

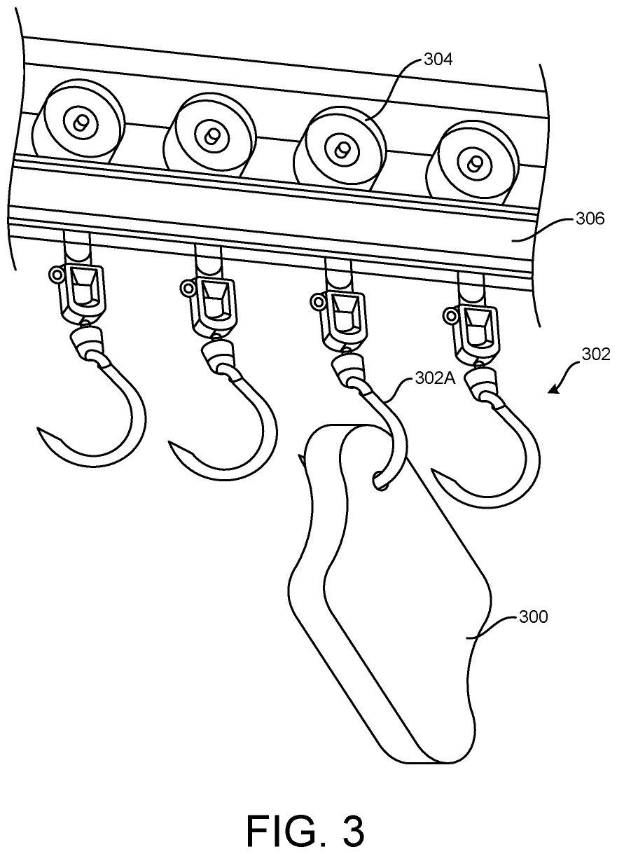

FIG. 3 shows an example of a product 300 (e.g., meat or a meat portion) transported using a conveyor hanger 302A. The conveyor hanger 302A extends from (e.g., is attached to) a trolley 304 that is configured to move along a track 306. The conveyor hanger 302A, trolley 304 and track 306 can be used with one or more other examples described elsewhere herein.

The system can include multiple conveyor hangers 302 similar or identical to the conveyor hanger 302A. For example, the conveyor hangers 302 can be advanced along the track 306 by one or more motors. The product 300 can be supported by the conveyor hanger 302A during transport. For example, the conveyor hanger 302A can be a meat hook that at least in part pierces meat or a meat portion so that the meat or meat portion hangs from the meat hook. As another example, the product 300 can otherwise rest on the conveyor hanger 302A. Multiple products (e.g., more than one instance of the product 300) can be carried by the conveyor hanger 302A. The product 300 can be carried by more than one of the conveyor hangers 302.

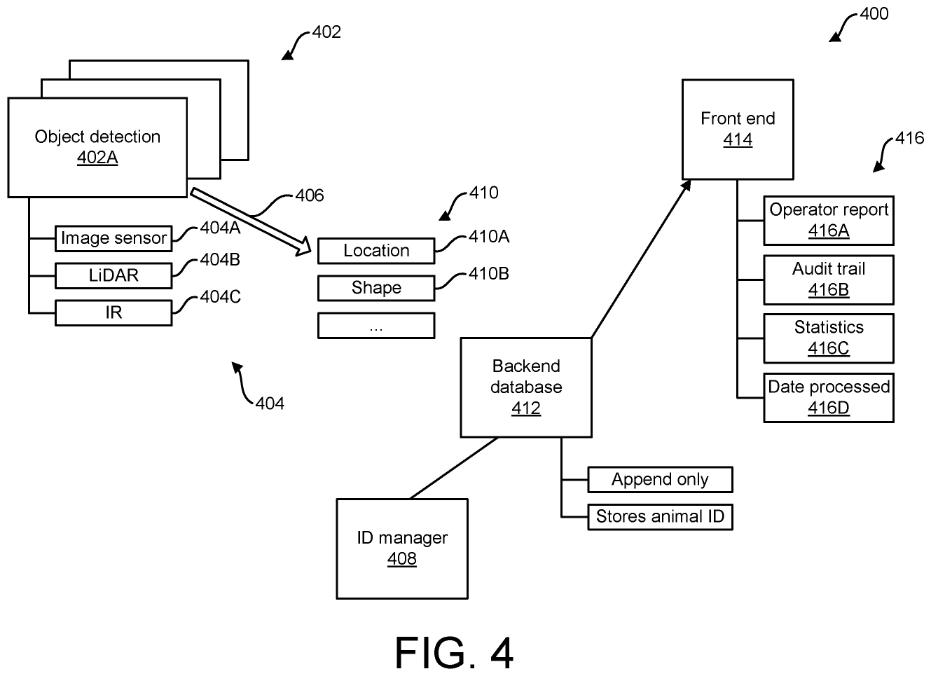

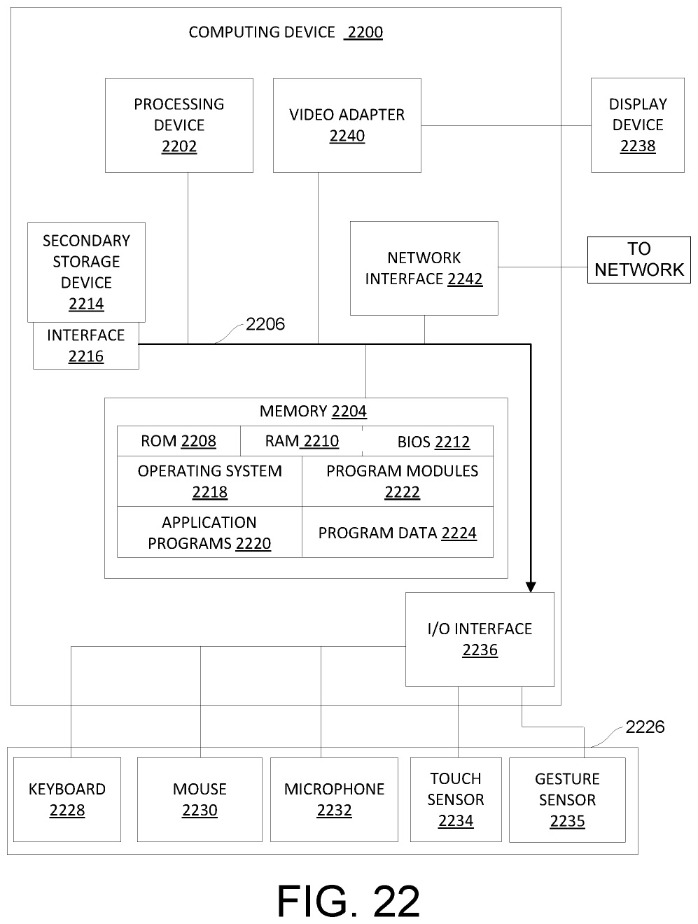

FIG. 4 shows a system 400 that supports tracking of animal sources during meat processing so that animal source tracing of animal source information can be performed. The system 400 can be used with one or more other examples described elsewhere herein. The system 400 is implemented at least in part using one or more processors executing instructions stored in one or more memories. For example, some or all components described below with reference to FIG. 22 can be used.

The system 400 includes one or more object detection systems 402. The object detection system 402 can include one or more sensors 404 and one or more frontend components to receive and process sensor outputs from the one or more sensors 404. Any of multiple types of the sensors 404 can be used. Here, an object detection system 402A includes one or more of an image sensor 404A, wherein the sensor output can include an image of the product; a LiDAR 404B, wherein the sensor output can include a LiDAR point cloud of the product; or an IR detector 404C, wherein the sensor output can include an IR image of the product. Others of the object detection systems 402 can include more, fewer, and/or different sensors. The frontend component(s) of the object detection system 402 can assign respective native IDs to the detected objects (e.g., products).

Each of the object detection systems 402 can, respectively, define events 406 for use by other aspects of the system 400, as schematically illustrated. The events 406 include sensor outputs (e.g., images, measurements) and the native IDs assigned for the detected objects. An ID manager 408 can use one or more heuristics 410 about the detected products (e.g., meat or meat portions). The heuristics 410 can include, but are not limited to, a location 410A of the meat or the meat portion at the conveyor belt, or a shape 410B of the meat or the meat portion. Other examples are provided below. Based on the heuristics 410, the ID manager 408 can associate two or more of the events 406 with each other. In some implementations, the ID manager 408 determines that two or more native IDs included in separate ones of the events 406 refer to the same product. In some implementations, the ID manager 408 determines that two or more events from separate ones of the object detection systems 402 refer to the same product. For example, with reference again briefly to FIG. 1, the ID manager 408 determines that the meat portion 126 to which the sensor 114-2 assigned the native ID 130 is the same product as the meat portion 126 to which the sensor 114-1 assigned the native ID 128. In some implementations, the ID manager 408 can detect, based on the events 406 and the heuristics 410, that a product is separated into two or more portions, or that two or more products are combined into a single product.

The ID manager 408 stores the events 406 in a backend that is configured so that the stored data is immutable. This can provide advantages regarding tracing of animal source records by ensuring that data, once entered, can only be appended to and not be changed or deleted. Here, the system 400 implements such a backend using an append-only database 412. Accordingly, the ID manager 408 can store the events 406 in the append-only database 412. In the append-only database 412, the events are associated with the animal ID. Particularly, this can establish an association between the animal ID and the native IDs that were assigned by the object detection systems 402. Such an association provide a useful benefit in that the object detection systems 402 are generally not aware of and may not have access to the animal ID of the animal whose meat they detect as objects during the meat processing. Rather, it is the ID manager 408 that establishes the association between the animal ID and the native IDs using heuristics about the meat or meat portions. Accordingly, the append-only database 412 is updated during the course of the meat processing to establish a data structure reflecting the tracking so that animal source tracing can be performed.

The system 400 can include a front end 414 that can be used for accessing the append-only database 412. The front end 414 can allow a user to review, or determine, any of multiple aspects 416 related to the meat processing. The aspects 416 can include, but are not limited to, an operator report 416A that can be run to gain insight into any of multiple livestock operators whose animals were subject to the meat processing, such as to determine the yield for a particular operator; an audit trail 416B that allows animal source tracing and/or other diagnostic reporting to be performed; statistics 416C that reflect the meat processing, including, but not limited to, by efficiency, throughput, production, cost, revenue, trends, averages and/or other characteristics; or a date processed metric 416D that can allow a day-by-day analysis of the meat processing. Other types of reporting can be used additionally or alternatively.

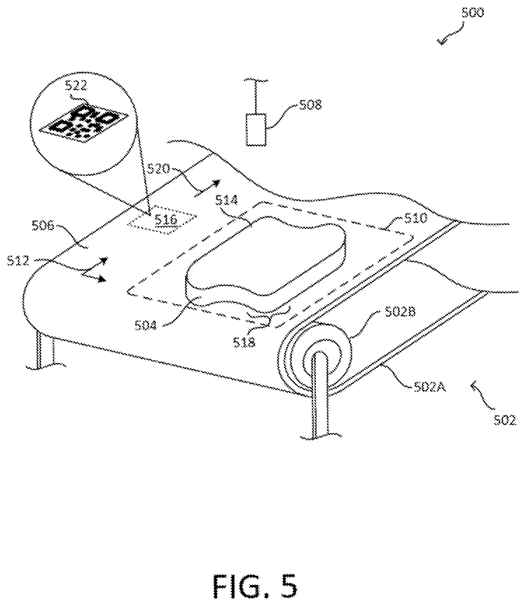

FIG. 5 shows some examples of heuristics 500 based on which events can be defined in methods and/or systems described herein. The heuristics 500 can be used with one or more other examples described elsewhere herein.

The heuristics 500 will be described with reference to an example environment that includes a conveyor 502 to transport products. In some implementations, the conveyor 502 is a belt conveyor and can include a conveyor belt 502A configured to be driven by a motor to rotate about or against one or more pulleys 502B. Only part of the conveyor 502 is shown for simplicity. A product 504 is currently being transported by the conveyor 502. For example, the product 504 can be positioned on a surface 506 of the conveyor belt 502A. A sensor 508 is positioned adjacent the conveyor 502 and can generate one or more types of sensor outputs characterizing the product 504 (e.g., meat or a meat portion). As mentioned earlier, such sensor output(s) can be used when processing events that are defined by an object detection system.

The heuristics 500 can include a bounding box 510 defined relative to at least one sensor output, here relative to the sensor output of the sensor 508. For example, the sensor 508 is an image sensor that generates an image of the product 504 and of at least part of the surface 506. Object detection can be performed on at least that image to define the bounding box 510 as a boundary establishing where the product 504 can been detected as an object. The bounding box 510 can have any shape including but not limited to as shown.

The heuristics 500 can include spatial coordinates for the product 504. The spatial coordinates can be defined relative to a coordinate system 512 that is here schematically illustrated. The spatial coordinates can indicate a position of the product 504 at the conveyor belt 502A. For example, x/y-coordinates can be used.

The heuristics 500 can include an image of the product 504 captured by the sensor 508. The sensor 508 can be or include an image sensor that produces an image of the product 504 and of at least part of the surface 506.

The heuristics 500 can include a shape 514 of the product 504. The shape 514 can include an outer periphery of the product 504 as viewed from the perspective of the sensor 508.

The heuristics 500 can include a conveyor pattern 516 positioned at the conveyor belt 502A. The sensor 508 can detect that the product 504 is positioned at or near the conveyor pattern 516 as a way of distinguishing the product 504 from other products being processed.

The heuristics 500 can include a location of the product 504 at the conveyor belt 502A. For example, the location can be defined relative to the edges or other recognizable characteristics of the conveyor belt 502A.

The heuristics 500 can include a confidence of detection at the conveyor belt 502A regarding the product 504. For example, the bounding box 510 can be associated with a confidence value, defined based on a metric in the object detection, that indicates how likely is the detection of the product 504 within the bounding box 510.

The heuristics 500 can include an outline of the product 504. For example, the sensor 508 can generate an image that reflects some or all of the periphery of the product 504.

The heuristics 500 can include a contour 518 of the product 504. The contour 518 can be determined as part of object recognition and can distinguish the product 504 from other products being processed.

The heuristics 500 can include a volume of the product 504. The sensor 508 can perform depth perception (including, but not limited to, by generating a LiDAR point cloud) and can thereby determine the volume of the product 504. The volume can distinguish the product 504 from other products being processed.

The heuristics 500 can include a velocity 520 of the product 504. The velocity 520 indicates how fast the product 504 is transported by the conveyor 502. For example, this can guide a determination of when or how fast the product 504 may reach or traverse any given zone in the processing environment.

The conveyor pattern 516 is used together with one or more other heuristics about the regarding the product 504 to define events about the process. In some implementations, the conveyor pattern 516 can include a QR code 522. For example, the QR code 522 can serve as additional identification helping a frontend system keep track of the product 504 during the part of the processing where the conveyor 502 is used. The conveyor pattern 516 can be located adjacent the product 504 on the conveyor 502. When the conveyor pattern 516 is inside the bounding box 510, the sensor 508 can detect the conveyor pattern 516. In some implementations, the conveyor pattern 516 is used together with the spatial coordinates defined relative to the coordinate system 512 to identify the product 504 and distinguish the product 504 from other items that may be on the conveyor 502. As another example, the conveyor pattern 516 can be used together with the image of the product 504 captured by the sensor 508 (e.g., a visual depiction together with a non-repeating pattern can uniquely identify the product 504). As another example, the conveyor pattern 516 can be used together with the shape 514 of the product 504 (e.g., the product 504 being identified using a combination of pattern and a distinctive shape). As another example, the conveyor pattern 516 can be used together with the location of the product 504 defined relative to the edges or other recognizable characteristics of the conveyor belt 502A (e.g., the product 504 being identified using a combination of pattern and a specific location). As another example, the conveyor pattern 516 can be used together with the outline (e.g., some or all of the periphery of the product 504). As another example, the conveyor pattern 516 can be used together with the contour 518 of the product 504 (e.g., the product 504 being identified using a combination of pattern and a distinctive contour). As another example, the conveyor pattern 516 can be used together with the volume of the product 504. As another example, the conveyor pattern 516 can be used together with the velocity 520 of the product 504. Other approaches can be used.

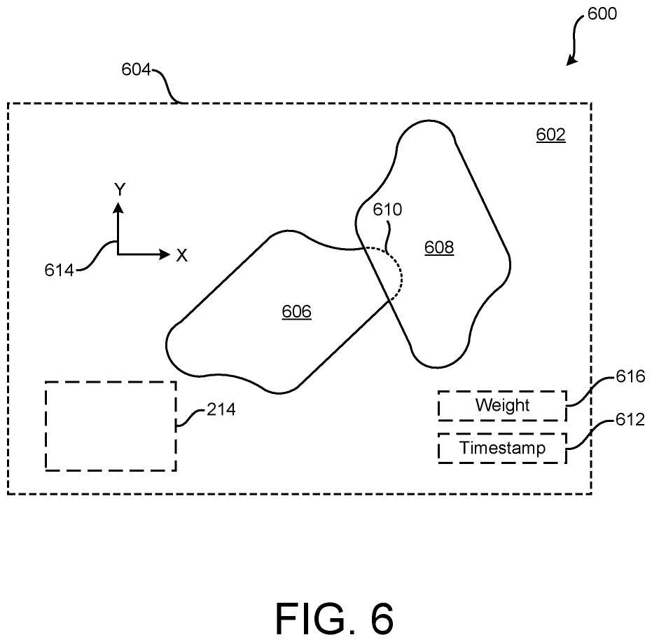

FIG. 6 shows other examples of heuristics 600 based on which events can be defined in methods and/or systems described herein. The heuristics 600 can be used with one or more other examples described elsewhere herein.

The heuristics 600 will be described with reference to an example environment that includes a conveyor belt 602 to transport products. Only the part of the conveyor belt 602 within a frame 604 is shown for simplicity. For example, the frame 604 can correspond to the range of a detector that is positioned adjacent the conveyor belt 602. Products 606 and 608 are currently being transported by the conveyor belt 602. The sensor can generate one or more types of sensor outputs characterizing the products 606 and/or 608 (e.g., meat or a meat portion). As mentioned earlier, such sensor output(s) can be used when processing events that are defined by an object detection system.

The heuristics 600 can include an overlap 610 between the products 606 and 608. For example, the product 608 can be positioned so as to partially obscure the view of the product 606 from the perspective of the sensor.

The heuristics 600 can include a timestamp 612 relating to the product 606 and/or 608. For example, the timestamp 612 can indicate when the product 606 and/or 608 entered or exited the conveyor belt 602; when the product 606 and/or 608 entered or exited a station positioned adjacent the conveyor belt 602; and/or when an action reflected by an event defined by an object detection system was performed regarding the product 606 and/or 608.

The heuristics 600 can include identification of a zone where the sensor detects the product 606 and/or 608. In some implementations, the frame represents the boundaries of a zone along the conveyor, wherein the products 606 and 608 are currently located within the zone.

The heuristics 600 can indicate a place along the conveyor belt 602 where the sensor most recently detected the product 606 and/or 608. In some implementations, the place can be specified using a coordinate system 614.

The heuristics 600 can indicate a weight 616 of the product 606 and/or 608. The sensor positioned adjacent the conveyor belt 602 can sense the weight of products being transported and can generate its sensor outputs accordingly.

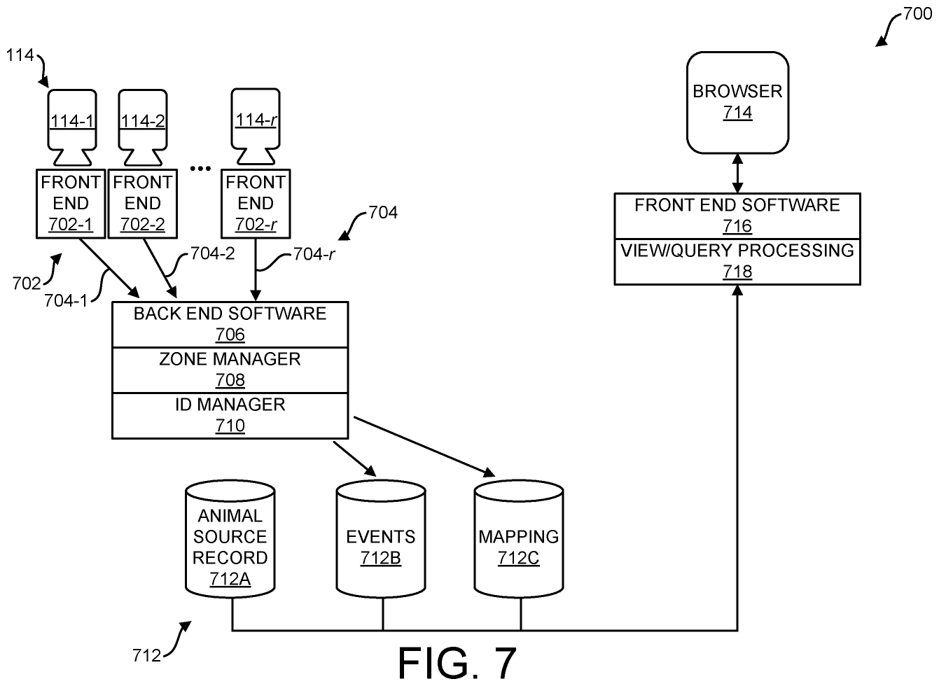

FIG. 7 shows another example of a system 700 that supports tracking of animal sources during meat processing so that animal source tracing of animal source information can be performed. The system 700 can be used with one or more other examples described elsewhere herein. The system 700 is implemented at least in part using one or more processors executing instructions stored in one or more memories. For example, some or all components described below with reference to FIG. 22 can be used.

The system 700 can include the sensors 114, here the sensors 114-1, 114-2 through 114-r are shown. Each of the sensors 114 can be provided with a corresponding one of frontend components 702, here frontend components 702-1, 702-2 through 702-r are shown. For example, each of the frontend components 702 can be integrated with a corresponding one of the sensors 114. The frontend components 702 and the sensors 114 can serve to perform object detection of products that are being transported in a process. Each of the frontend components 702 can assign respective native IDs to detected objects (i.e., detected products such as meat or meat portions). The frontend components 702 can also define events regarding the detected objects. For example, such events can include at least one or more native IDs and one or more forms of sensor output. Each of the frontend components 702 can define events 704, here are shown events 704-1 from the frontend component 702-1, events 704-2 from the frontend component 702-2, and events 704-r from the frontend component 702-r. In implementations involving meat processing, the frontend components 702 can define the events 704 without having access to an animal ID of the animal that is being processed.

The system 700 includes backend software 706. The backend software 706 can be executed to perform operations of forming associations between some or all of animal IDs, native IDs and product IDs, and also of persistently storing records regarding processes that were performed, to facilitate source tracing to find one or more product origins.

The backend software 706 can include or be used in conjunction with a zone manager 708. The zone manager 708 manages, during the process, processing of the meat or the first meat portion at any of the multiple zones. For example, the zone manager 708 can perform endzone processing.

The backend software 706 can include or be used in conjunction with an ID manager 710. The ID manager 710 can use one or more heuristics about the detected products (e.g., meat or meat portions) to facilitate tracking of the product(s) so that source tracing can be performed. The ID manager 710 can store one or more forms of data in an append-only database 712. In some implementations, the append-only database 712 includes an animal source record database 712A that includes the animal identifiers of the animals in the processing. For example, information can be added to the animal source record database 712A based on the deliveries of livestock to a processing plant. In some implementations, the animal source record database 712A is not included in the append-only database 712. In some implementations, the append-only database 712 includes an events database 712B in which the ID manager 710 stores the events 704 defined by the frontend components 702. In some implementations, the append-only database 712 includes a mapping database 712C that stores mappings between two or more sets of information handled by the ID manager 710. For example, mappings can be formed between product IDs and the one or more animal IDs that are the origins for the product(s) of that product ID. This can be characterized as a direct mapping that facilitates directly associating the animal ID with a product ID. As another example, mappings can be formed between product IDs and the native IDs, and separate mappings can be formed between the native IDs and the one or more animal IDs that are the origins for the meat or meat portions associated with the native IDs. This can be characterized as an indirect mapping that facilitates indirectly associating the animal ID with a product ID.

The system 700 can include a graphical user interface (GUI) 714. The GUI 714 can include any technology that facilitates interacting with, and/or obtaining information from, the components of the system 700. For example, the GUI 714 can include a browser being executed by a computer device. The GUI 714 can allow a user access to reporting software associated with the tracking performed in the system 700 and configured to generate one or more reports on source tracing. The GUI 714 can facilitate generation of one or more reports. For example, such a report can specify the source of one or more products (e.g., the animal source of meat or a meat portion).

In some implementations, the GUI 714 interfaces front end software 716. The front end software 716 can provide one or more functionalities 718 as part of the reporting. In some implementations, the functionalities 718 include a view function for the source tracing. For example, the view function can allow a user to view any or all aspects of tracked information including, but not limited to, native IDs, product IDs, events, images, sensor outputs, animal IDs, zone information, and/or timestamps. In some implementations, the functionalities 718 include a query function for the source tracing. For example, the query function can allow a user to search the append-only database(s) 712 based on one or more inputs (including, but not limited to, by searching based on a product ID of a product for which animal source tracing is to be performed). In some implementations, the front end software 716 can generate a report based on evaluating a direct association in the mapping database 712C. In some implementations, the front end software 716 can generate a report based on evaluating an indirect association in the mapping database 712C.

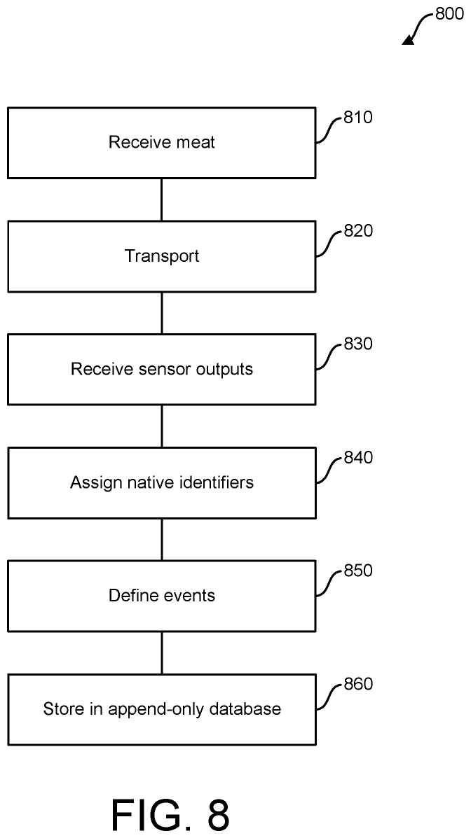

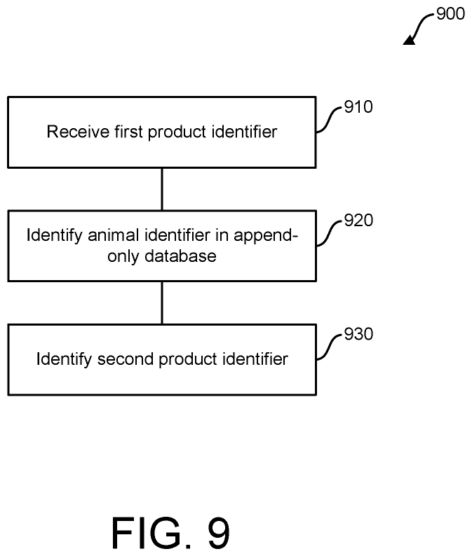

FIGS. 8-9 show examples of methods 800 and 900, respectively. The methods 800 and/or 900 can be used with one or more other examples described herein. More or fewer operations than shown can be performed. As another example, two or more operations can be performed in a different order unless otherwise indicated. Generally, the method 800 can be characterized as relating to tracking during a process, and the method 900 can be characterized as relating to tracing of origins for products of a process.

Beginning with the method 800, in an operation 810 meat is received. The meat is associated with an animal ID. For example, in FIG. 1 the meat 118 associated with the animal ID 106 can be received at a meat processing plant.

In an operation 820, the meat or a meat portion is transported on a conveyor during a process. Sensors are positioned along the conveyor. The meat or the meat portion are not physically marked with the animal ID. For example, in FIG. 1 the meat 118 and/or the meat portion 126 are transported on the conveyor 102 that has sensors 114.

In an operation 830, sensor outputs are received using the sensors during the process. Each of the sensor outputs characterizes the meat or the meat portion. For example, in FIG. 1 any or all of the sensors 114 can generate outputs.

In an operation 840, a frontend component can assign native IDs to the meat or the meat portion using the sensor outputs. For example, in FIG. 1 the native IDs 122, 128 and/or 130 can be assigned.

In an operation 850, the frontend component can define events regarding the process. The events are defined based on heuristics about the meat or the meat portion. For example, in FIG. 7 the events 704 can be defined.

In an operation 860, an ID manager can store the events in an append-only database. The append-only database associates the native IDs with the animal ID. For example, in FIG. 7 the ID manager 710 can store the events 704 in the append-only database 712.

Turning now to the method 900, in an operation 910, a first product ID from packaging of a meat portion is received. Source tracing is to be performed for the meat portion. For example, in FIG. 2 any of the product IDs 222 can be received because of a need to trace the origin(s) of that product.

In an operation 920, an animal ID in an append-only database can be identified. The append-only database stores events defined regarding a process in which meat or the meat portion separated from the meat were transported using a conveyor. The events have been defined based on heuristics about the meat or the meat portion. Native identifiers were assigned to the meat or to the meat portion using sensor outputs of sensors positioned along the conveyor. The append-only database associates the native identifiers with the at least one animal identifier. For example, in FIG. 7 the append-only database 712 can be accessed using a product ID to find at least one animal ID that is relevant to the source tracing.

In an operation 930, at least one second product ID can be identified. For example, in FIG. 7 and based on searching the append-only database 712, another one of the product IDs 222 (FIG. 2) can be identified because the product associated with that other product ID may have a common animal origin with the product of the first product ID.

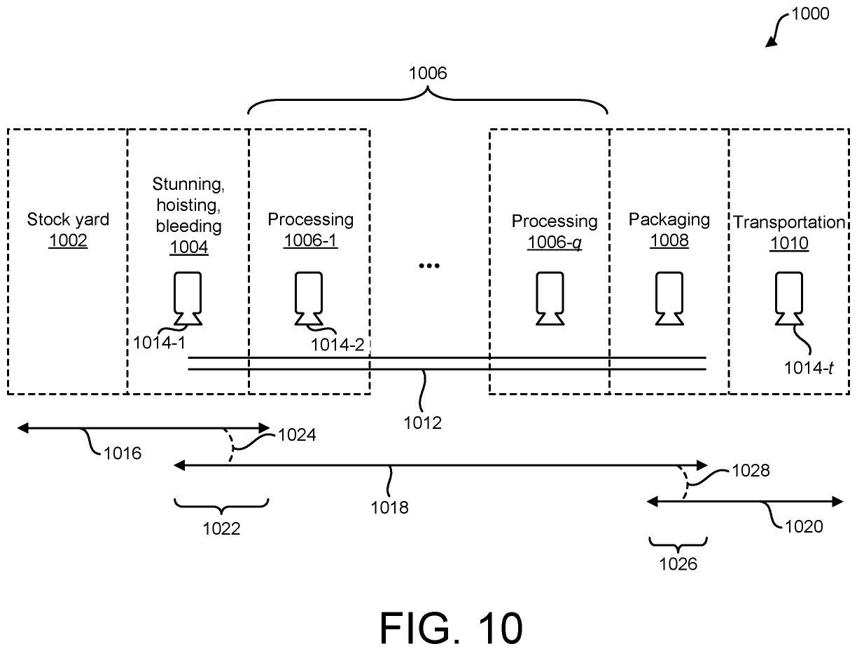

FIG. 10 shows an example of meat processing 1000. The meat processing 1000 can be used with one or more other examples described elsewhere herein. The meat processing 1000 can be performed at a processing plant and schematically shows how meat can be processed beginning with live animals at a stock yard in stage 1002, through slaughter in a stage 1004, quartering or other harvesting to obtain portions of the meat in one or more stages 1006, thereafter packaging at a stage 1008, and finally transportation at a stage 1010. The meat processing 1000 as shown need not correspond to the physical layout of a processing plant, but does exemplify the flow over time of operations involving each of multiple animals. Proper thermal management is performed as part of executing the meat processing 1000. At one or more of the stages a carcass, meat or meat portion can be chilled, such as by bringing it into contact with a cold surface or by surrounding it with a cold environment (e.g., a refrigerated space).

At the stage 1002 live animals can be maintained in one or more pens of a stock yard. The animals can be transported from elsewhere (e.g., from a feedlot) by vehicle, or the animals may have been raised in the vicinity of the stock yard. Some sorting among the animals can be performed at the stock yard. For example, animals can be categorized by type, size, age, health, or other characteristics. Animals in the stock yard can be individually identified using an animal ID (e.g., the animal ID 106 in FIG. 1).

At the stage 1004, animals can be brought from the stock yard individually or as part of a group for slaughter. The slaughter is performed in accordance with applicable laws and regulations. In some implementations, the animal is first stunned to render the animal unconscious. For example, the stunning can be performed by administering an electric shock to the animal using a stun gun. The unconscious animal can be placed on a conveyor 1012 that is here schematically illustrated using lines extending through at least stages 1004-1008. In some implementations, the conveyor 1012 at least in part includes an overhead track in the processing plant. For example, the animal can be hoisted onto a moveable meat hook suspended at the overhead track. The unconscious animal can be bled to death by administering one or more cuts. Blood draining from the animal can be collected using drains and/or other vessels.

The meat processing 1000 can make use of multiple sensors in monitoring the transportation of meat or meat portions by the conveyor 1012. Here/number of sensors 1014-1, 1014-2, . . . 1014-1 are shown as part of the meat processing 1000, where t=2, 3, 4 . . . . Each of the sensors.

The stage 1006 can include one or more individual substages where the animal carcass is processed. Here q number of substages 1006-1 through 1006-q are shown as part of the meat processing 1000, where q=1, 2, 3, . . . . In any of the substages the meat or a meat portion thereof can be processed. For example, the processing can involve dividing and/or trimming the meat or the meat portion. The sensors 1014-1, 1014-2, . . . 1014-t are monitoring the meat or the meat portion during the meat processing 1000. For example, native identifiers are assigned to the meat or the meat portion, and events can be defined based on heuristics about the meat or the first meat portion.

In the respective substages of the stage 1006, any of various operations can be performed on the animal carcass or on meat or a meat portion thereof. Examples include, but are not limited to, removal of heads or feet from the carcass, removal of hide/skin, evisceration, splitting of the carcass, or separation of meat portions from the carcass and/or from each other. An animal ID with which the living animal was marked can be deliberately or inadvertently removed during any of the substages. For example, when the animal tag 108 holding the animal ID 106 in FIG. 1 is attached to the ear of the animal, the animal ID 106 becomes separated from the rest of the carcass when the head is removed, if not earlier in the meat processing 1000. One or more items can result at the end of the stage 1006. Examples include, but are not limited to, the animal carcass, or meat, or a meat portion thereof. That is, the resulting items can all be of the same type, or they can include two or more different types of resulting item.

The items resulting from the stage 1006 are subjected to packaging in the stage 1008. This can involve wrapping the item(s) with, or otherwise covering them by, one or more types of packaging material. In some implementations, a polymer material (e.g., a plastic film) can be used. Vacuum packing can be used. For example, the items can be placed in plastic bags or other containers that are evacuated and sealed. A package can be labeled with one or more identifiers. In some implementations, a product ID is placed on the packaging material as a unique identifier for the packaged product(s). The items resulting from the stage 1006 can be packaged one or more times. For example, a carcass, meat or a meat portion can first be vacuum packaged inside a plastic pouch, and multiple packaged products can be placed inside a shipping container (e.g., a box or crate) for transportation. Material such as ice or dry ice can be included when packaging the items resulting from the stage 1006 to ensure proper thermal conditions.

The transportation that is initiated at the stage 1010 can be performed by one or more types of vehicle. In some implementations, boxes or crates or other containers can be placed onto a truck, railway car, or an aircraft for transportation to a next (or final) destination. The product ID on the packaging material can be used to control and monitor such distribution.

The meat processing 1000 enables animal source tracing for any individual meat or meat portion. For example, this can allow audit tracking to be performed in the event meat or meat portion is found to be defective such that a recall should be performed. The animal source tracing is facilitated by the monitoring performed using the sensors 1014-1, 1014-2, . . . 1014-t, in which native IDs are assigned, and by the events that were defined based on heuristics of the meat or meat portion. The storage of such event data and native IDs in an append-only database ensures that reliable audit tracking can be performed.

As mentioned above, the live animal is associated with an animal ID (e.g., by way of the animal tag 108 of FIG. 1 being attached to the animal) for a portion of the meat processing 1000. For example, an ear tag can remain attached to the animal until a certain point of the meat processing 1000, and therefore provides a unique identification during that phase. Here, an arrow 1016 extends during the stages 1002, 1004, and at least part of the stage 1006. The arrow 1016 schematically illustrates a phase during which the animal ID is physically attached to the animal.

Multiple examples described herein illustrate that native IDs are assigned and heuristics-based events are defined during the meat processing 1000. Based on the tracking that can be performed by an ID manager, such native IDs facilitate identification of meat or a meat portion during the meat processing 1000. That is, the identification based on native IDs can be performed also when the meat or the meat portion are not physically marked with the animal ID. Here, an arrow 1018 extends during the stages 1004, 1006, and at least part of the stage 1008. The arrow 1018 schematically illustrates a phase during which the native ID is a source of identification for the meat or meat portion.

As mentioned above, one or more product IDs can be applied to packaging material with which the meat or meat portion is packaged in the stage 1008. Here, an arrow 1020 extends during the stages 1008 and 1010. The arrow 1020 schematically illustrates a phase during which the product ID is a source of identification for the meat or meat portion.

Animal source tracing is facilitated because overlap exists between the phases represented by the arrows 1016, 1018, and 1020. An overlap 1022 here exists between the arrows 1016 and 1018. For example, the overlap 1022 ensures that meat or a meat portion that is identified during the meat processing 1000 can be traced to the corresponding animal by way of an association 1024. An overlap 1026 here exists between the arrows 1018 and 1020. For example, the overlap 1026 ensures that meat or a meat portion having a product ID can be traced to the corresponding native ID(s) during the meat processing 1000 by way of an association 1028. From the native ID(s), the meat or a meat portion can be traced to the corresponding animal by way of the association 1024. As such, the association 1028 and/or 1024 can facilitate an audit tracking of meat or a meat portion back to its corresponding animal.

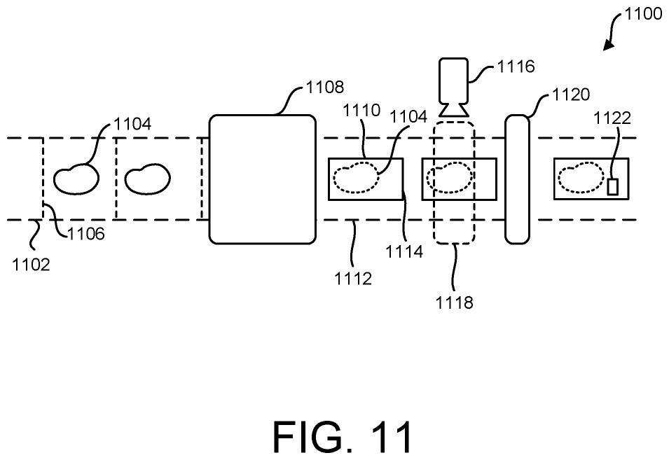

FIG. 11 shows an example of a packaging apparatus 1100 that can be used as part of the meat processing 1000 of FIG. 10. The packaging apparatus 1100 can be used with one or more other examples described elsewhere herein. In some implementations, the packaging apparatus 1100 is used in the stage 1008 (FIG. 10). The packaging apparatus 1100 is schematically illustrated and operates as follows. A conveyor 1102 here extends substantially in a left-right direction in the illustration. Items 1104 are transported by the conveyor 1102, here in a direction from left to right. For example, each of the items 1104 can be meat or a meat portion that is being subjected to meat processing at a plant or other facility. In some implementations, the conveyor 1102 is configured for the items 1104 to rest on top of the conveyor 1102. For example, the conveyor 1102 can have partitions 1106 forming compartments that each holds one or more of the items 1104.

The conveyor 1102 leads to a packaging machine 1108 that is configured to package meat or meat portions using packaging material. In some implementations, the packaging material includes pouches 1110 (e.g., of a polymer material, such as plastic bags), wherein the packaging machine 1108 positions one or more of the items 1104 inside each of the pouches 1110. The item 1104 can be actuated to enter the pouch 1110 by the motion imparted by the conveyor 1102. As another example, the packaging machine 1108 can include a mechanical actuator that either advances the item 1104 into the pouch 1110, or that moves the pouch 1110 so as to envelop the item 1104. As another example, the pouch 1110 can be positioned with its opening facing in an upward direction relative to the packaging machine 1108, and the item 1104, upon being conveyed to the opening, can enter the pouch 1110 by the force of gravity.

Multiple instances of the pouches 1110 are here seen exiting the packaging machine 1108 at an opposite side from the conveyor 1102. Each of the pouches 1110 includes at least one of the items 1104, which may or may not be visible through the packaging material (here shown in phantom for illustrative purposes). At the exit, the pouches 1110 are being transported by a conveyor 1112. The pouches 1110 being transported by the conveyor 1112 have not yet been sealed after exiting the packaging machine 1108, and each of the pouches has an opening 1114.

One or more sensors 1116 can be positioned so that its range 1118 of detection (e.g., a field of view) includes some portion of the conveyor 1112. As the pouches 1110 enter the range 1118, the sensor 1116 can generate an output characterizing the item 1104. A frontend system can define one or more events regarding the pouch 1110 based on heuristics about the item 1104.

The packaging apparatus 1100 can include a labeler 1120. The labeler 1120 is configured to label each of the pouches 1110 (or another package including the item 1104) with a product ID 1122. The product ID 1122 is specific to the respective package of the pouch 1110. In some implementations, the labeler 1120 is configured to print the product ID 1122 onto the packaging material. Printing can be done using any of multiple printing techniques, including but not limited to, using inkjet technology, stamping, or surface abrasion. In some implementations, the labeler 1120 is configured to apply a label onto the packaging material, wherein the label includes the product ID 1122. For example, a label preprinted with the product ID 1122 can be adhered to the packaging material, or printing can be performed after the label is applied to the packaging material. The conveyor 1112 can transport the pouches 1110 to another area of the processing facility. For example, at such other area further packaging can be performed.

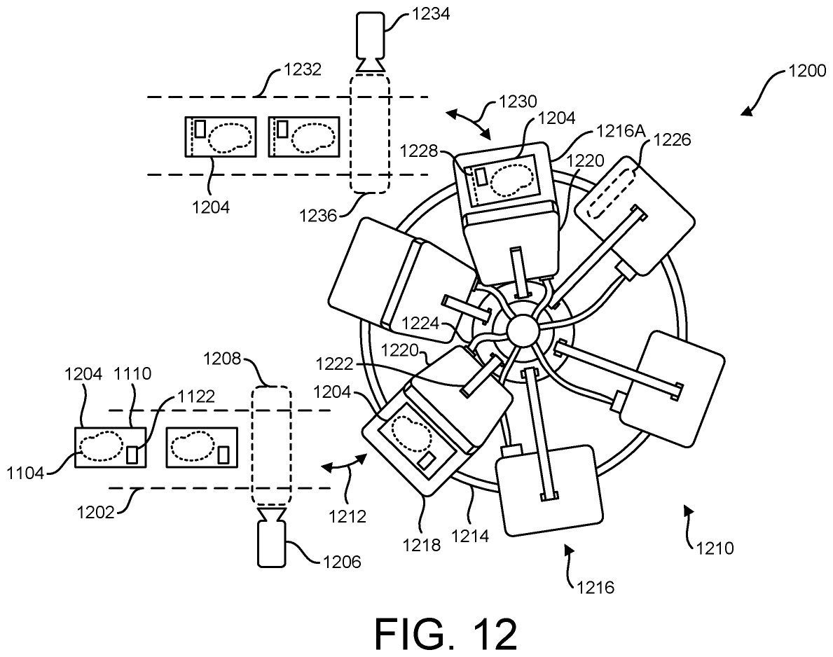

FIG. 12 shows another example of a packaging apparatus 1200 that can be used as part of the meat processing of FIG. 10. The packaging apparatus 1200 can be used with one or more other examples described elsewhere herein. In some implementations, the packaging apparatus 1200 is used in the stage 1008 (FIG. 10). The packaging apparatus 1200 is schematically illustrated and operates as follows. A conveyor 1202 here extends substantially in a left-right direction in the illustration. Items 1204 are transported by the conveyor 1202, here in a direction from left to right. For example, each of the items 1204 can include one of the pouches 1110 of FIG. 11 including at least one of the items 1104, the packaging material having the product ID 1122. In some implementations, the conveyor 1202 is configured for the items 1204 to rest on top of the conveyor 1202.

One or more sensors 1206 can be positioned so that its range 1208 of detection (e.g., a field of view) includes some portion of the conveyor 1202. As the items 1204 enter the range 1208, the sensor 1206 can generate an output characterizing the item 1204. A frontend system can define an event regarding the item 1204 based on heuristics about the item 1204.

The conveyor 1202 leads to a packaging machine 1210 that is configured to package meat or meat portions using packaging material. An arrow 1212 here schematically illustrates that each of the items 1204 exits the conveyor 1202 and enters the packaging machine 1210. For example, the arrow 1212 represents movement by a mechanical actuator and/or a gravity drop.

In some implementations, the packaging machine 1210 is configured for vacuum sealing each of the pouches 1110 of the items 1204. The packaging machine 1210 can include a rotary support 1214 that is configured for moving each of vacuum packaging sealers 1216 along a path of a continuous loop. The continuous loop can have any shape, including but not limited to, a circular shape. The packaging machine 1210 here has six of the vacuum packaging sealers 1216 arranged radially around the periphery of the rotary support 1214. For example, the rotary support 1214 can cause the vacuum packaging sealers 1216 to be rotated in a counterclockwise direction in the present illustration.

Each of the vacuum packaging sealers 1216 includes a base 1218 and a lid 1220 that fits against the base 1218. The lid 1220 can be actuated between at least open and closed positions using an arm 1222. For example, the arm 1222 is electrically or hydraulically actuated. When the lid 1220 is closed, the base 1218 and the lid 1220 can form a vacuum chamber that can accommodate at least one of the items 1204. For example, the vacuum chamber can be evacuated by removing air using a vacuum conduit 1224. When the lid 1220 is open, the item 1204 can be placed in, or removed from, the vacuum chamber.

Each of the vacuum packaging sealers 1216 can include a sealer 1226 configured to seal the packaging material of the pouch 1110. The sealer 1226 is here schematically illustrated and can include an electrically heated element configured to partially melt a polymer material of the pouches 1110 and thereby seal the openings thereof. A vacuum packaging sealer 1216A is one of the vacuum packaging sealers 1216 that is currently positioned near an end of the operation cycle of the packaging machine 1210. As such, the lid 1220 of the vacuum packaging sealer 1216A has been opened after completion of the evacuation and sealing operations. The item 1204 inside the vacuum packaging sealer 1216A has a weld 1228 created by the sealer 1226 that closes the previously existing opening of the pouch 1110.

An arrow 1230 here schematically illustrates that each of the items 1204 exits the packaging machine 1210 and enters a conveyor 1232. For example, the arrow 1230 represents movement by a mechanical actuator and/or a gravity drop.

One or more sensors 1234 can be positioned so that its range 1236 of detection (e.g., a field of view) includes some portion of the conveyor 1232. As the items 1204 enter the range 1236, the sensor 1234 can generate an output characterizing the item 1204. A frontend system can define an event regarding the item 1204 based on heuristics about the item 1204. The conveyor 1232 can transport the items 1204 to another area of the processing facility. For example, at such other area further packaging can be performed.

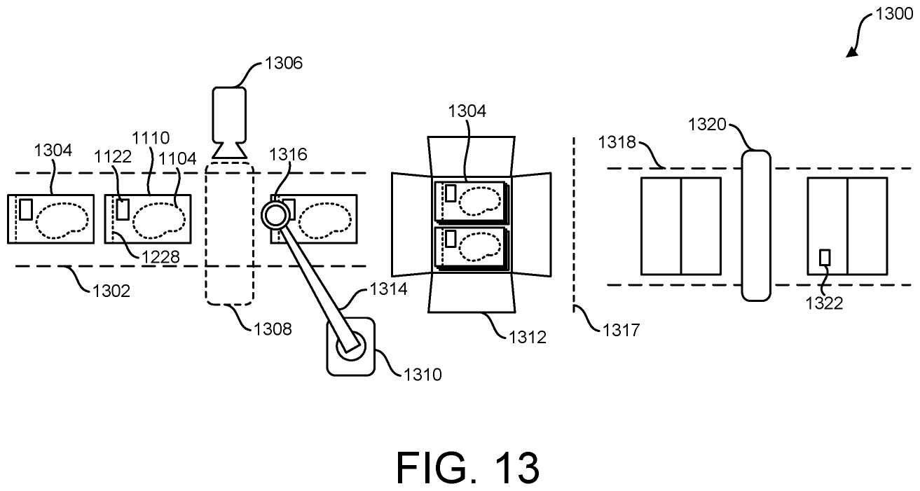

FIG. 13 shows another example of a packaging apparatus 1300 that can be used as part of the meat processing of FIG. 10. The packaging apparatus 1300 can be used with one or more other examples described elsewhere herein. In some implementations, the packaging apparatus 1200 is used in the stage 1008 (FIG. 10). The packaging apparatus 1300 is schematically illustrated and operates as follows. A conveyor 1302 here extends substantially in a left-right direction in the illustration. Items 1304 are transported by the conveyor 1302, here in a direction from left to right. For example, each of the items 1304 can include one of the pouches 1110 of FIG. 11 including at least one of the items 1104, the packaging material having the product ID 1122 and being sealed by the weld 1228. In some implementations, the conveyor 1302 is configured for the items 1304 to rest on top of the conveyor 1302.

One or more sensors 1306 can be positioned so that its range 1308 of detection (e.g., a field of view) includes some portion of the conveyor 1302. As the items 1304 enter the range 1308, the sensor 1306 can generate an output characterizing the item 1304. A frontend system can define an event regarding the item 1304 based on heuristics about the item 1304.

The packaging apparatus 1300 includes a robot 1310 configured to move the items 1304 from the conveyor 1302 and place the items 1304 inside a container 1312. For example, the container 1312 can include a box (e.g., a cardboard box) or a crate (e.g., of metal or plastic). The robot 1310 has an arm 1314 that is moveable so that a lifter 1316 can take each of the items 1304 at the conveyor 1302 and place the item 1304 inside the container 1312. For example, the lifter 1316 can seize the item 1304 by way of mechanical grasping (e.g., using one or more claws) and/or air suction.

When one or more of the items 1304 has been placed inside the container 1312, the container 1312 can be closed for transportation and/or storage. A line 1317 schematically illustrates one or more operations for closing the container 1312.

A conveyor 1318 here extends substantially in a left-right direction in the illustration. The containers 1312 are transported by the conveyor 1318, here in a direction from left to right, after having been closed. In some implementations, the conveyor 1318 is configured for the container 1312 to rest on top of the conveyor 1318.

The packaging apparatus 1300 can include a labeler 1320. The labeler 1320 is configured to label each of the containers 1312 (or another package including the item 1104 of FIG. 11) with a product ID 1322. The product ID 1322 is specific to the respective package of the container 1312. In some implementations, the labeler 1320 is configured to print the product ID 1322 onto the packaging material. Printing can be done using any of multiple printing techniques, including but not limited to, using inkjet technology, stamping, or surface abrasion. In some implementations, the labeler 1320 is configured to apply a label onto the packaging material, wherein the label includes the product ID 1322. For example, a label preprinted with the product ID 1322 can be adhered to the packaging material, or printing can be performed after the label is applied to the packaging material. The conveyor 1318 can transport the containers 1312 to another area of the processing facility. For example, at such other area further packaging and/or transportation can be performed.

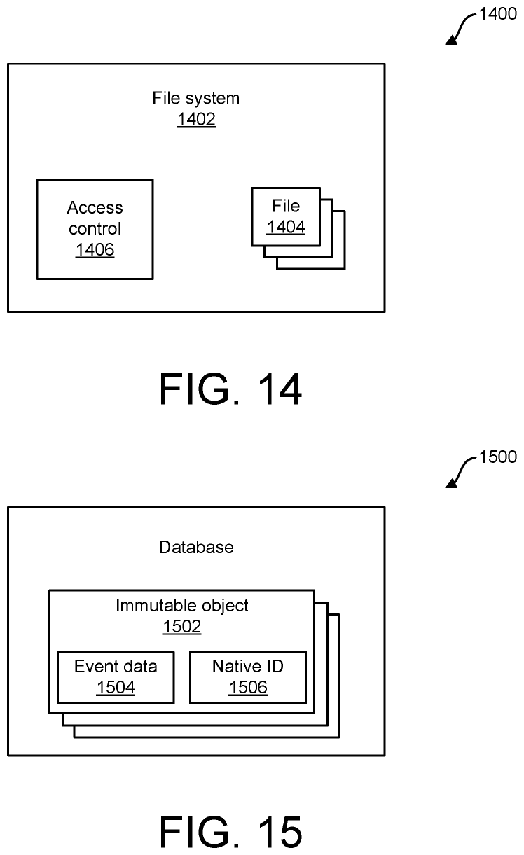

FIG. 14 shows an example of an append-only database 1400 implemented using a file system 1402. The file system 1402 can be used with one or more other examples described elsewhere herein. The file system 1402 can be implemented using some or all components described below with reference to FIG. 22. The file system 1402 is operated by an operating system to control storage and retrieval of data. The file system 1402 can define methods and/or data structures for storing and/or retrieving the data. The file system 1402 can be implemented for any of multiple kinds of storage devices using any of various media. Files 1404 are maintained by the file system 1402. The files 1404 can include data that has been handled by an ID manager in a system for managing meat processing. For example, the data in the files 1404 can include events, native IDs, timestamps, heuristics, and/or sensor output. The file system 1402 uses an access control 1406 to regulate how the files 1404 are accessed. Particularly, the access control 1406 can control that the files 1404 are altered solely in an append-only fashion. This can ensure that animal source tracing is enabled, because historical event information about meat and meat portions is not changed or deleted, but can instead only be appended to.

FIG. 15 shows an example of an append-only database 1500 implemented using immutable objects 1502. The append-only database 1500 can be used with one or more other examples described elsewhere herein. The append-only database 1500 can be implemented using some or all components described below with reference to FIG. 22. The append-only database 1500 is configured so that the immutable objects 1502 cannot be altered, and so that additional instances of the immutable objects 1502 can be created without modifying the existing immutable object(s) 1502. In some implementations, each of the immutable objects 1502 is defined, by the programming of the append-only database 1500, so that its state cannot be altered after the immutable object 1502 is created. Here, each of the immutable objects 1502 includes event data 1504 and at least one native ID 1506 that are restricted against being changed. In some implementations, the immutable object 1502 can include one or more immutable variables whose contents do not change. In some implementations, the immutable object 1502 can include one or more immutable fields whose contents do not change. The immutability can ensure that animal source tracing is enabled, because historical event information about meat and meat portions is not changed or deleted, but can instead only be appended to.

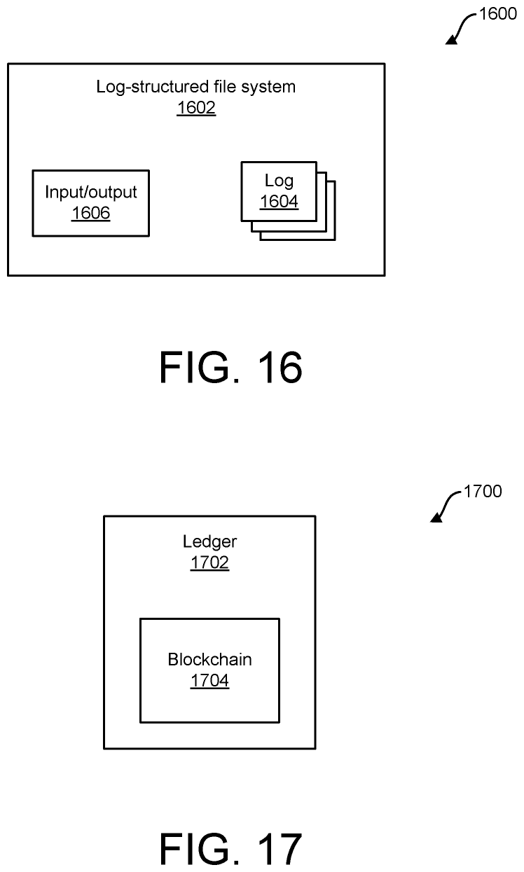

FIG. 16 shows an example of an append-only database 1600 implemented using a log-structured file system 1602. The append-only database 1600 can be used with one or more other examples described elsewhere herein. The log-structured file system 1602 can be implemented using some or all components described below with reference to FIG. 22. The log-structured file system 1602 includes one or more logs 1604 that can be accessed using an input/output (I/O) function 1606. The I/O function 1606 controls writing to, and reading from, the log(s) 1604. In some implementations, the log(s) 1604 can be a circular buffer or a quasi-circular buffer (e.g., the log can be divided into segments where the head of the log advances into free segments that are not adjacent). That is, the log-structured file system 1602 is configured so that the I/O function 1606 appends new data (e.g., events/native IDs) without modifying or deleting data from the log(s) 1604.

FIG. 17 shows an example of an append-only database 1700 implemented using a ledger 1702 with a blockchain 1704. The append-only database 1700 can be used with one or more other examples described elsewhere herein. The ledger 1702 and the blockchain 1704 can be implemented using some or all components described below with reference to FIG. 22. The ledger 1702 is digital information and can be designed to be distributed among multiple entities (e.g., as a distributed ledger) or can be maintained without distribution. The blockchain 1704 is configured to include a growing list of records (e.g., events and native IDs) that can be securely linked together using cryptographic hashes (e.g., the outputs of a cryptographic hash function that maps arbitrary strings into strings of fixed size). Because of the secure linking between the records on the blockchain 1704, the append-only database 1700 ensures that animal source tracing is enabled and that historical event information about meat and meat portions is not changed or deleted, but can instead only be appended to.

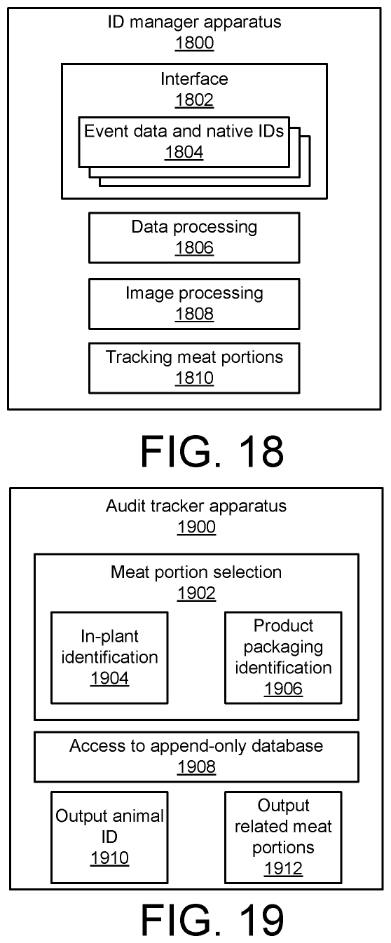

FIG. 18 shows an example of an ID manager apparatus 1800. The ID manager apparatus 1800 can be used with one or more other examples described elsewhere herein. The ID manager apparatus 1800 can be implemented using some or all components described below with reference to FIG. 22. The ID manager apparatus 1800 includes an interface 1802 for the identifier manager apparatus to receive data 1804. The data 1804 can include events defined regarding meat processing, and native IDs assigned to meat or meat portion in the meat processing using outputs of the sensor(s). The ID manager apparatus 1800 includes a data processing component 1806 that can associate the native IDs with an animal identifier for the meat or the meat portion so as to enable animal source tracing. The data processing component 1806 can store the events and/or other information in an append-only database to ensure that meat or meat portions remain traceable and that historical data is not lost. The ID manager apparatus 1800 can include an image processing component 1808 that can analyze sensor output that includes images. For example, the image processing component 1808 can process images for which native IDs have been assigned for detected objects, so that the ID manager apparatus 1800 can perform tracking of the source(s) of meat and meat portions. The ID manager apparatus 1800 can include a tracking component 1810. In some implementations, the tracking component 1810 can be used for tracking meat and meat portions during the meat processing, and for performing animal source tracing for any meat or meat portion.

FIG. 19 shows an example of an audit tracker apparatus 1900. The audit tracker apparatus 1900 can be used with one or more other examples described elsewhere herein. The audit tracker apparatus 1900 can be implemented using some or all components described below with reference to FIG. 22. The audit tracker apparatus 1900 can be used for performing animal source tracing for any identified meat or meat portion. Such animal source tracing can be performed before the meat or meat portion leaves the facility where the meat processing is being performed, and/or can be performed for a meat or meat portion that has already been transported from the facility. Tracing can be initiated using a meat portion selection component 1902.

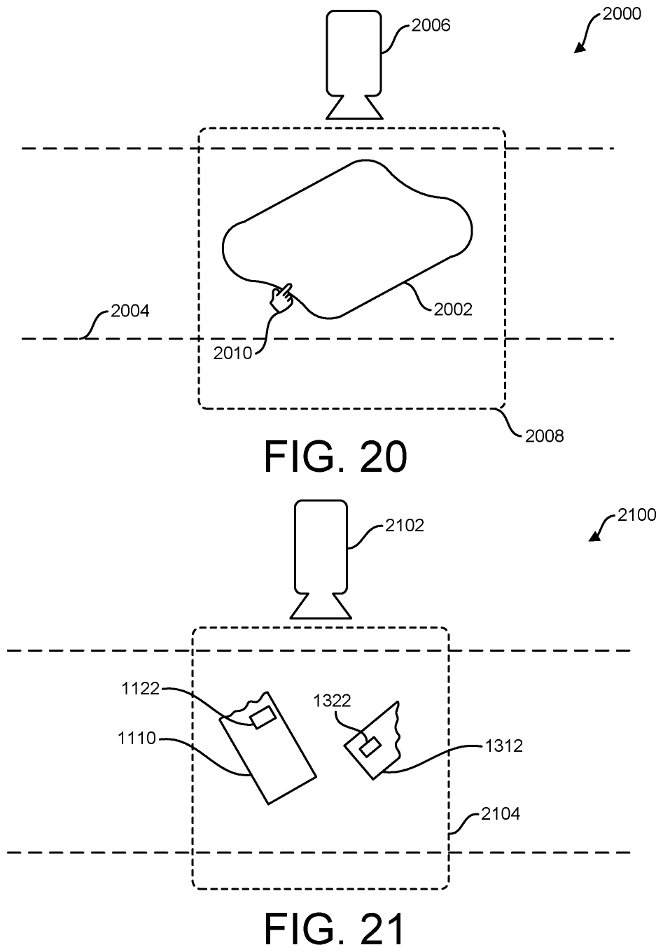

In the former of these two situations, the audit tracker apparatus 1900 can use an in-plant identification component 1904 of the meat portion selection component 1902 to facilitate animal source tracing for meat or meat portion that remains present at the facility. Examples will now be described. FIG. 20 shows an example 2000 of initiating an audit based on meat or a meat portion. In this example, an item 2002 that is either meat or a meat portion can be transported by a conveyor 2004 at the facility where meat processing is being performed. A decision can be made that animal source tracing should be performed for the item 2002. For example, a detection may have been made that the item 2002 is either of high quality or is of low quality. In the former case it may be useful to know the origin of the item 2002 such that more animals from the same source can be obtained. In the latter case, it may become necessary to either subject meat or meat portions from the same animal to additional processing to remedy the low quality, or to execute a recall procedure to remove all meat and meat portions from the animal from the meat processing.

Regardless of the reason why animal source tracing is to be performed, the animal source tracing can be initiated in response to an identification that the item 2002 is to be the subject of tracing. Such identification can include point toward the item 2002 in a way that is detected by the meat processing system. One or more sensors 2006 can be positioned so that its range 2008 of detection (e.g., a field of view) includes some portion of the conveyor 2004. A pointer 2010 is here present inside the range 2008 and is therefore detectable as pointing toward the item 2002. For example, the pointer can be a mechanical object of a recognizable shape, or can be the hand of a person at the processing facility. That is, the act of pointing to the item 2002, as represented by the pointer 2010 being detected by the sensor 2006, can trigger the system to perform animal source tracing regarding meat or a meat portion of the item 2002. The output of the tracing (e.g., an identification of one or more animals and/or of associated meat or meat portions from the same animal) can be generated and presented to a user.

Turning now to the latter of the two situations above where the animal source tracing is to be performed for a meat or meat portion that has already been transported from the facility, the audit tracker apparatus 1900 can use product packaging identification component 1906 of the meat portion selection component 1902 to facilitate animal source tracing for the meat or meat portion. Examples will now be described. FIG. 21 shows an example 2100 of initiating an audit based on a product identifier. In this example, meat or a meat portion has been processed and packaged, the packaged product has been marked with at least one product ID (e.g., as described above with reference to FIGS. 11-13), and the package has been transported from the processing facility. A decision can be made that animal source tracing should be performed for the meat or meat portion that was transported in the package. For example, the reasons can be any of those discussed above.

The animal source tracing can be initiated in response to presentation of the product ID of the meat or meat portion. One or more sensors 2102 can be positioned to have a range 2104 of detection (e.g., a field of view). The product ID for the meat or meat portion at issue can be placed inside the range 2104 for detection. Here, the pouch 1110 bearing the product ID 1122 can be placed in the range 2104. For example, the pouch 1110 was already opened and the item 1104 (FIG. 11) was removed from the packaging. As another example, the container 1312 (or a portion thereof) bearing the product ID 1322 can be placed in the range 2104. That is, the detection of the product ID 1122 and/or 1322 can trigger the system to perform animal source tracing regarding meat or a meat portion that was once held inside the packaging. The output of the tracing (e.g., an identification of one or more animals and/or of associated meat or meat portions from the same animal) can be generated and presented to a user.

Returning now to the audit tracker apparatus 1900, the animal source tracing can be performed based on accessing an append-only database. Here, the audit tracker apparatus 1900 includes an access component 1908. For example, the access component 1908 can trigger an ID manager to trace the relevant source(s) for a meat or meat portion.

The audit tracker apparatus 1900 can output the result(s) of the animal source tracing in one or more ways. In some implementations, an output 1910 regarding one or more animal IDs can be generated, the animal ID(s) corresponding to the animal(s) from which the meat or meat portion originated. In some implementations, an output 1912 regarding one or more related meats or meat portions can be generated. For example, the related meats or meat portions can be identified by the output 1912 based on the related meats or meat portions having originated from the same animal(s) as the meat or meat portion at issue.

FIG. 22 illustrates an example architecture of a computing device 2200 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 22 can be used to execute the operating system, application programs, and/or software modules (including the software engines) described herein.

The computing device 2200 includes, in some embodiments, at least one processing device 2202 (e.g., a processor), such as a central processing unit (CPU). A variety of processing devices are available from a variety of manufacturers, for example, Intel or Advanced Micro Devices. In this example, the computing device 2200 also includes a system memory 2204, and a system bus 2206 that couples various system components including the system memory 2204 to the processing device 2202. The system bus 2206 is one of any number of types of bus structures that can be used, including, but not limited to, a memory bus, or memory controller; a peripheral bus; and a local bus using any of a variety of bus architectures.

Examples of computing devices that can be implemented using the computing device 2200 include a desktop computer, a laptop computer, a tablet computer, a mobile computing device (such as a smart phone, a touchpad mobile digital device, or other mobile devices), or other devices configured to process digital instructions.

The system memory 2204 includes read only memory 2208 and random access memory 2210. A basic input/output system 2212 containing the basic routines that act to transfer information within computing device 2200, such as during start up, can be stored in the read only memory 2208.

The computing device 2200 also includes a secondary storage device 2214 in some embodiments, such as a hard disk drive, for storing digital data. The secondary storage device 2214 is connected to the system bus 2206 by a secondary storage interface 2216. The secondary storage device 2214 and its associated computer readable media provide nonvolatile and non-transitory storage of computer readable instructions (including application programs and program modules), data structures, and other data for the computing device 2200.

Although the example environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 2214 and/or system memory 2204, including an operating system 2218, one or more application programs 2220, other program modules 2222 (such as the software engines described herein), and program data 2224. The computing device 2200 can utilize any suitable operating system, such as Microsoft Windows™, Google Chrome™ OS, Apple OS, Unix, or Linux and variants and any other operating system suitable for a computing device. Other examples can include Microsoft, Google, or Apple operating systems, or any other suitable operating system used in tablet computing devices.

In some embodiments, a user provides inputs to the computing device 2200 through one or more input devices 2226. Examples of input devices 2226 include a keyboard 2228, mouse 2230, microphone 2232 (e.g., for voice and/or other audio input), touch sensor 2234 (such as a touchpad or touch sensitive display), and gesture sensor 2235 (e.g., for gestural input). In some implementations, the input device(s) 2226 provide detection based on presence, proximity, and/or motion. In some implementations, a user may walk into their home, and this may trigger an input into a processing device. For example, the input device(s) 2226 may then facilitate an automated experience for the user. Other embodiments include other input devices 2226. The input devices can be connected to the processing device 2202 through an input/output interface 2236 that is coupled to the system bus 2206. These input devices 2226 can be connected by any number of input/output interfaces, such as a parallel port, serial port, game port, or a universal serial bus. Wireless communication between input devices 2226 and the input/output interface 2236 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 2238, such as a monitor, liquid crystal display device, light-emitting diode display device, projector, or touch sensitive display device, is also connected to the system bus 2206 via an interface, such as a video adapter 2240. In addition to the display device 2238, the computing device 2200 can include various other peripheral devices (not shown), such as speakers or a printer.

The computing device 2200 can be connected to one or more networks through a network interface 2242. The network interface 2242 can provide for wired and/or wireless communication. In some implementations, the network interface 2242 can include one or more antennas for transmitting and/or receiving wireless signals. When used in a local area networking environment or a wide area networking environment (such as the Internet), the network interface 2242 can include an Ethernet interface. Other possible embodiments use other communication devices. For example, some embodiments of the computing device 2200 include a modem for communicating across the network.

The computing device 2200 can include at least some form of computer readable media. Computer readable media includes any available media that can be accessed by the computing device 2200. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 2200.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 22 is also an example of programmable electronics, which may include one or more such computing devices, and when multiple computing devices are included, such computing devices can be coupled together with a suitable data communication network so as to collectively perform the various functions, methods, or operations disclosed herein.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
receiving meat that is associated with an animal identifier;
transporting the meat or a first meat portion separated from the meat on a conveyor during a process, wherein sensors are positioned along the conveyor, and wherein the meat and the first meat portion are not physically marked with the animal identifier;
receiving sensor outputs using the sensors during the process, each of the sensor outputs characterizing the meat or the first meat portion;
assigning, by a frontend component implemented using a first processor and a first memory, native identifiers to the meat or to the first meat portion using the sensor outputs;
defining, by the frontend component, events regarding the process, the events being defined based on heuristics about the meat or the first meat portion; and
storing, by an identifier manager implemented using a second processor and a second memory, the events in an append-only database, wherein the append-only database associates the native identifiers with the animal identifier.

2. (canceled)

3. (canceled)

4. The method of claim 1, wherein the conveyor first transports the meat, and wherein after separation of the first meat portion from the meat, the conveyor transports the first meat portion.

5. The method of claim 4, wherein a station is positioned adjacent the conveyor, and wherein the separation of the first meat portion from the meat occurs at the station.

6. The method of claim 5, further comprising detecting that the meat enters the station from the conveyor, and subsequently detecting that the first meat portion begins to be transported by the conveyor at the station.

7. The method of claim 6, further comprising registering, after subsequently detecting that the first meat portion begins to be transported by the conveyor at the station, that the first meat portion was separated from the meat at the station.

8. The method of claim 5, further comprising detecting that the meat enters the station from the conveyor, and subsequently detecting that the first meat portion and a second meat portion begin to be transported by the conveyor at the station.

9. The method of claim 8, further comprising registering, after subsequently detecting that the first meat portion and the second meat portion begin to be transported by the conveyor at the station, that the first meat portion and the second meat portion were separated from the meat at the station.

10. The method of claim 1, wherein the frontend component assigns the native identifiers without the frontend component having access to the animal identifier.

11. The method of claim 1, wherein the heuristics include at least one selected from the group consisting of:
a bounding box defined relative to at least one of the sensor outputs;
spatial coordinates for the meat or for the first meat portion, wherein the conveyor includes a conveyor belt and the spatial coordinates indicate a position of the meat or the first meat portion at the conveyor belt;
an image of the meat or the first meat portion, wherein at least one of the sensors includes an image sensor that generates the image of the meat or the first meat portion;
a shape of the meat or the first meat portion;
an overlap between the first meat portion and a second meat portion at the conveyor belt;
a conveyor pattern positioned at the conveyor belt;
a location of the meat or the first meat portion at the conveyor belt;
a confidence of detection at the conveyor belt regarding the meat or the first meat portion;
an outline of the meat or the first meat portion;
a contour of the meat or the first meat portion or the first meat portion; and
a volume of the meat or the first meat portion or the first meat portion.

12. The method of claim 11, wherein the heuristics include at least the conveyor pattern and wherein the conveyor pattern includes a QR code.

13. (canceled)

14. The method of claim 1, wherein the heuristics include at least one selected from the group consisting of:
a timestamp for the meat or the first meat portion during the process;
a velocity of the meat or the first meat portion;
identification of a zone along the conveyor where any of the sensors detects the meat or the first meat portion;
a place along the conveyor where any of the sensors most recently detected the meat or the first meat portion; and
a weight of the first meat portion or the first meat portion.

15. The method of claim 1, further comprising managing, during the process, processing of the meat or the first meat portion at any of multiple zones defined along the conveyor.

16. The method of claim 15, wherein the multiple zones include an end zone of the process, the method further comprising applying packaging to the meat or to the first meat portion at the end zone.

17. The method of claim 16, further comprising affixing a marking to the packaging, the marking including a product identifier for the meat or for the first meat portion.

18. The method of claim 17, further comprising tracing a source of the meat or a source of the first meat portion using the product identifier and the append-only database.

19. The method of claim 18, further comprising providing a report regarding the source of the meat or the source of the first meat portion.

20. (canceled)

21. (canceled)

22. (canceled)

23. A system comprising:
a conveyor to transport, during a process, meat or a first meat portion separated from the meat, the meat being associated with an animal identifier, wherein the meat and the first meat portion are not physically marked with the animal identifier;
sensors that are positioned along the conveyor, the sensors generating sensor outputs during the process, each of the sensor outputs characterizing the meat or the first meat portion;
an append-only database; and
one or more processors to execute instructions stored in one or more memories to operate:
a frontend component that assigns native identifiers to the meat or to the first meat portion using the sensor outputs, and that defines events regarding the process based on heuristics about the meat or the first meat portion; and
an identifier manager that stores the events in the append-only database, wherein the append-only database associates the native identifiers with the animal identifier.

24. The system of claim 23, wherein the conveyor includes a conveyor belt providing a surface on which the meat or the first meat portion is placed.

25. The system of claim 23, wherein the conveyor includes conveyor hangers from which the meat or the first meat portion hangs.

26. (canceled)

27. The system of claim 23, further comprising:
multiple zones defined along the conveyor; and
a zone manager, operated by the one or more processors, that manages, during the process, processing of the meat or the first meat portion at any of the multiple zones.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A packaging apparatus comprising:
one or more sensors;
a packaging machine configured to package meat or meat portions using packaging material, wherein the packaging machine packages one or more of the meat or the meat portions into each of multiple packages, the meat or meat portions arriving at the packaging apparatus as part of meat processing in which native identifiers are assigned to the meat or to the meat portion using outputs of the one or more sensors, wherein events defined regarding the meat processing are stored in an append-only database; and
a labeler configured to label each of the multiple packages with a corresponding product identifier, the product identifier being specific to the respective package.

44. (canceled)

45. (canceled)

46. (canceled)

47. (canceled)

48. The packaging apparatus of claim 43, wherein the labeler is configured to print the product identifier onto the packaging material

49. The packaging apparatus of claim 43, wherein the labeler is configured to apply a label onto the packaging material, wherein the label includes the product identifier.

50. (canceled)

51. (canceled)

52. (canceled)

53. (canceled)

54. (canceled)

55. (canceled)

56. (canceled)

57. (canceled)
